(19) United States
(12) Patent Application Publication
(10) Pub. No.: US 2017/0091872 A1
(43) Pub. Date: Mar. 30, 2017

(54) APPARATUS AND METHOD FOR EVALUATING DRIVING ABILITY, AND PROGRAM FOR CAUSING COMPUTER TO PERFORM METHOD

(71) Applicant: RENESAS ELECTRONICS CORPORATION, Tokyo (JP)

(72) Inventor: Shunsuke OKUMURA, Tokyo (JP)

(21) Appl. No.: 15/259,567

(22) Filed: Sep. 8, 2016

(30) Foreign Application Priority Data
Sep. 24, 2015 (JP) 2015-187066
Sep. 24, 2015 (JP) 2015-187118
May 18, 2016 (JP) 2016-099693

(51) Int. Cl. G06Q 40/08; G06K 9/00; G08G 1/01

(52) U.S. Cl. CPC G06Q 40/08; G08G 1/0112; G06K 9/00845

(57) ABSTRACT

A system for evaluating a safe driving ability includes: a memory for storing a program including a plurality of instructions; at least one processor for executing each of the instructions; and a database. The processor is programmed to, when the plurality of instructions are executed, detect a state of a vehicle operation by a driver: detect an event occurring in the vehicle; acquire a surrounding situation of the vehicle; detect an event occurring around the vehicle; calculate a difference between driver's reaction times; and evaluate a driving ability of the driver. The database stores a driving event and a surrounding event, information about the time of occurrence of each of these events, reaction time data, safe driving ability evaluation results, and the like.

This nonprovisional application is based on Japanese Patent Application No. 2015-187066 filed on Sep. 24, 2015, No. 2015-187118 filed on Sep. 24, 2015, and No. 2016-099693 filed on May 18, 2016, with the Japan Patent Office, the entire contents of which are hereby incorporated by reference.

### BACKGROUND OF THE INVENTION

Field of the Invention

The present disclosure relates to a technique for evaluating a driving ability, and more particularly to a technique for evaluating a driving ability in consideration of states of a vehicle and its surroundings.

Description of the Background Art

As our society is aging, the number of elderly people driving automobiles is also increasing, which leads to an increase in number of accidents caused by elderly people. As a result, the paid vehicle insurance expense has been increasing, so that appropriate re-calculation of the insurance fees is demanded.

As to calculation of the vehicle insurance fees, for example, Japanese Patent Laying-Open No. 2002-259708 (PTD 1) discloses a technique for “calculating an appropriate vehicle insurance fee in consideration of the maintenance and management state of a vehicle”. The technique provides “use state detecting means (7, 8) for detecting a use state of a vehicle; data input means (15) for inputting date about maintenance or management of the vehicle; and insurance fee calculating means (20) for calculating a vehicle insurance fee based on the detection result and the input data” (See [Abstract]).

### SUMMARY OF THE INVENTION

The conventional technique allows detection of abrupt operations of an accelerator, a brake and the like during vehicle driving. However, the accidents caused typically by elderly people may not result from such abrupt operations. Thus, the technique for more precisely clarifying the causal relation of such accidents is demanded.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing the configuration of each function implemented by a system 100.

FIG. 2 is a block diagram showing part of components implementing an on-vehicle apparatus 200.

FIG. 3 is a block diagram showing the hardware configuration of on-vehicle apparatus 200.

FIG. 4 is a flowchart showing a part of the process performed by a processor 310 provided in on-vehicle apparatus 200.

FIG. 5A is a diagram conceptually showing the axis of coordinates of a vehicle 500 according to an embodiment.

FIG. 5B is a diagram showing values of the acceleration in the X-axis direction that are obtained before and after a smoothing process.

FIG. 5C is a diagram showing values of the acceleration in the Y-axis direction that are obtained before and after a smoothing process.

FIG. 6 is a flowchart showing a part of the process performed by a processor 310.

FIG. 7 is a diagram conceptually showing a manner of date storage in a RAM 330.

FIG. 8 is a flowchart showing a part of the process performed by processor 310.

FIG. 9 is a flowchart showing a part of the process performed by processor 310 for calculating a reaction time, according to an aspect.

FIG. 10 is a flowchart showing a part of the process performed by processor 310 for searching for a pair event.

FIG. 11 is a diagram conceptually showing a manner of data storage in a memory 320.

FIG. 12 is a diagram conceptually showing a manner of data storage in a reaction time database 160.

FIG. 13 is a diagram conceptually showing a manner of data storage in memory 320.

FIG. 14 is a flowchart showing a part of the process performed by processor 310 for evaluating the driving ability of a vehicle driver.

FIG. 15 is a diagram showing an image of distribution of reaction times relative to an event ET01.

FIG. 16 is a diagram conceptually showing a manner of data storage in a safe driving ability evaluation result database 180.

FIG. 17 is a diagram showing the relation between a person concerned who uses data obtained by on-vehicle apparatus 200 and the data.

FIG. 18 is a diagram showing an example of the configuration of a system 1800.

FIG. 19 is a diagram showing a manner in which reaction time information and driving record information obtained from a plurality of users are sent to a server 1720 of a vehicle insurance company.

FIG. 20 is a diagram conceptually showing the configuration of a system 2000 according to an embodiment.

FIG. 21 is a diagram conceptually showing a manner of data storage in memory 320 that implements system 2000.

FIG. 22 is a diagram showing event pairs.

FIG. 23 is a diagram conceptually showing the configuration of a system 2300.

FIG. 24 is a diagram showing the configuration of an on-vehicle apparatus 2400.

FIG. 25 is a block diagram showing the configuration of functions implemented by a system 2500.

FIG. 26 is a block diagram showing part of components implementing on-vehicle apparatus 2600.

FIG. 27 is a flowchart showing a part of the process performed by processor 310 provided in on-vehicle apparatus 2600.

FIG. 28 is a flowchart showing a part of the process performed by processor 310 for generating ideal driving event data in the on-vehicle apparatus according to an embodiment.

FIG. 29 is a diagram conceptually showing a manner of data storage in memory 320.

FIG. 30 is a diagram showing the relation between ideal driving events and actual driving events.

FIG. 31 is a diagram conceptually showing a manner of data storage in memory 320.

FIG. 32 is a flowchart showing a part of the process performed by processor 310.

FIG. 33 is a diagram showing a manner of deriving evaluation results.

FIG. 34 is a diagram showing the relation between a person concerned who uses data obtained by on-vehicle apparatus 2600 and the data.

FIG. 35 is a diagram showing an example of the configuration of a system 3500.

FIG. 36 is a diagram conceptually showing the configuration of a system 3600.

FIG. 37 is a diagram showing the configuration of an on-vehicle apparatus 3700.

FIG. 38 is a block diagram showing the hardware configuration of a computer 3800 implementing a server.

### DESCRIPTION OF THE PREFERRED EMBODIMENTS

Embodiments of the present invention will be hereinafter described with reference to the accompanying drawings. In the following description, the same components are designated by the same reference characters. Names and functions thereof are also the same. Therefore, detailed description thereof will not be repeated.

First, the technical idea related to the present disclosure will be hereinafter described. The technique disclosed in the present specification is implemented as an on-vehicle apparatus mounted in a vehicle, by way of example. This on-vehicle apparatus is configured to detect a driving event and a surrounding event (the “surrounding event” used herein means an event occurring in a surrounding area of the vehicle), and calculate the time difference therebetween, thereby measuring data of the driver's reaction speed to evaluate the driver's driving ability. The sensor mounted in the vehicle serves as an operation state detection unit to obtain information such as speed, acceleration and the like. The on-vehicle apparatus serves as a driving event detection unit to detect events such as acceleration, deceleration, right turns, and left turns, and store these events and the time of detection of each of these events as driving events. Also, the on-vehicle apparatus serves as a surrounding situation acquisition unit to acquire, from a sensor mounted in the vehicle, moving image data around the vehicle equipped with the on-vehicle apparatus and the information about the distance between the vehicle and an obstacle. The on-vehicle apparatus serves as a surrounding event detection unit to detect surrounding events including: the existence or absence of a signal; the state of the signal; the existence or absence of a preceding vehicle; ON or OFF of a brake lamp; the existence or absence of a pedestrian; and the like. The on-vehicle apparatus stores the surrounding event and the time of detection of this surrounding event as a surrounding event.

Based on the contents including the driving event and the surrounding event, the time of occurrence of the driving event, and the time of occurrence of the surrounding event, the on-vehicle apparatus serves as a reaction time measurement unit to store, as reaction time data, information about each of the corresponding surrounding event and driving event, and the difference between the times of occurrences of these events.

Based on the reaction time data and the data table used for determining the safe driving ability prepared in advance, the on-vehicle apparatus or a computer having received the data from the on-vehicle apparatus evaluates the vehicle driver's driving ability in view of the length of each reaction time. The computer is used, for example, by the administrator who uses the data obtained from the on-vehicle apparatus. For example, the administrator may include an insurance company that provides vehicle insurance, an administrative agency that manages road administration, and the like.

[System Configuration]

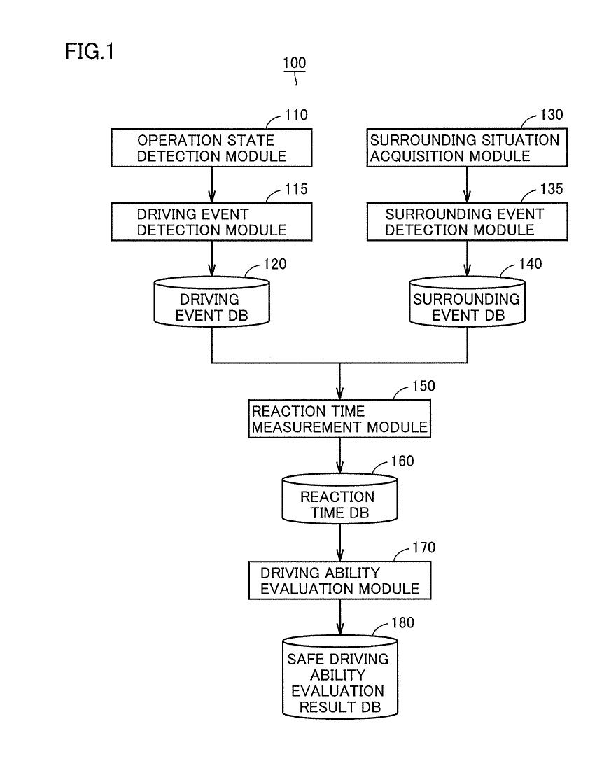

Referring to FIG. 1, the configuration of a system 100 according to an embodiment will be hereinafter described. FIG. 1 is a block diagram showing the configuration of each function implemented by system 100.

In an aspect, system 100 includes: an operation state detection module 110; a driving event detection module 115; a driving event database (DB) 120; a surrounding situation acquisition module 130; a surrounding event detection module 135; a surrounding event database (DB) 140; a reaction time measurement module 150; a reaction time database (DB) 160; a driving ability evaluation module 170; and a safe driving ability evaluation result database (DB) 180. The process performed by each module is implemented, for example, by causing a processor of a computer to execute each instruction included in a program stored in a memory.

In an aspect, the processor serves as operation state detection module 110 to detect the operation state of the vehicle (for example, an automobile) by the user (a driver) who receives service from the system. The operation state includes, for example, the degree of pressing an accelerator pedal by the user, the traveling speed of the vehicle, the operating state of an ABS (Anti-lock Brake System), time, engine rotation speed and changes in the engine rotation speed, setting of an automatic transmission (parking, reverse, neutral, drive, and the like), the use status of a turn signal lamp, the use status of a car-navigation system, the ON/OFF status of a headlamp, the use status of an air-conditioner, and the like. Operation state detection module 110 receives a signal showing the operation state from each sensor or each device mounted in a vehicle. Furthermore, operation state detection module 110 may detect the degree of acceleration or deceleration based on the signal output from an acceleration sensor. Furthermore, the processor may detect the vehicle's current position using a GPS (Global Positioning System).

In an aspect, the processor serves as driving event detection module 115 to detect the state of the vehicle or the event occurring in the vehicle based on the detected operation state. For example, the event may include acceleration, deceleration, left turns, right turns, ON and OFF of a light, and the like. The processor associates the detected event with the time of detection of the event, and stores the associated result in driving event database 120.

Driving event database 120 may be implemented as a hard disk of the computer constituting system 100 or, in another aspect, as an external storage device connected to the computer.

In an aspect, the processor serves as surrounding situation acquisition module 130 to acquire the surrounding situation of the vehicle. The surrounding situation is expressed by moving image data around the vehicle (for example, front, rear, right, left, and the like) or expressed as information about the distance between the vehicle and an obstacle, detected by a sensor.

In an aspect, the processor serves as surrounding event detection module 135 to detect an event occurring around the vehicle. This event includes, for example, the existence or absence of a signal, the state of the signal, the existence or absence of a preceding vehicle, ON or OFF of a brake lamp, the existence or absence of a pedestrian, and the like.

Surrounding event database 140 associates the event detected in the surrounding event detection unit with the time of detection of the event, and stores the associated result.

In an aspect, the processor serves as reaction time measurement module 150 to calculate the difference between the driver's reaction times based on (i) the time information associated with the driving event stored in driving event database 120 and (ii) the time information associated with the surrounding event stored in surrounding event database 140.

Reaction time database 160 stores the difference value measured by reaction time measurement module 150 as reaction time data.

In an aspect, the processor serves as driving ability evaluation module 170 to evaluate the driving ability of the vehicle driver based on (i) the reaction time data stored in reaction time database 160 and (ii) the data table prepared in advance by the provider of this service or the third-party organization for evaluation of the safe driving ability.

Safe driving ability evaluation result database 180 stores the data about the performed evaluation. For example, safe driving ability evaluation result database 180 stores the driving event, the surrounding event, the information about the time of occurrence of each of these events, the reaction time data, the safe driving ability evaluation results, and the like.

In an aspect, system 100 is implemented by an apparatus mounted in a vehicle (which will be also hereinafter referred to as an “on-vehicle apparatus”) and a computer system that receives data from the on-vehicle apparatus. The computer system has a well-known configuration, and includes at least a keyboard and other input devices, a monitor and other output devices, a hard disk, a RAM (Random Access Memory) and other storage devices, and a computing device like at least one CPU (Central Processing Unit). Since the configuration of such a computer system is well known, further detailed explanation thereof will not be repeated. In another aspect, the process performed by the computer system may be performed while being distributed in cloud computer systems arranged at a plurality of points. Accordingly, all of the processes may be performed by a plurality of CPUs. In this case, the processes may be performed collectively as a whole.

In still another aspect, all of the above-described processes may be implemented in the on-vehicle apparatus.

[Configuration of on-Vehicle Apparatus 200]

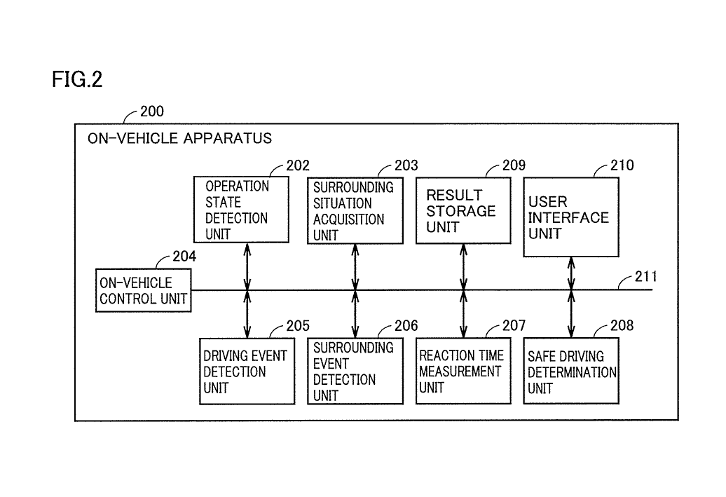

Referring to FIG. 2, an on-vehicle apparatus 200 according to an embodiment will be hereinafter described. FIG. 2 is a block diagram showing part of components implementing on-vehicle apparatus 200.

On-vehicle apparatus 200 operate as: an operation state detection unit 202; a surrounding situation acquisition unit 203; an on-vehicle control unit 204; a driving event detection unit 205; a surrounding event detection unit 206; a reaction time measurement unit 207; a safe driving determination unit 208; a result storage unit 209; and a user interface unit 210. Each of the components is connected to a control bus 211.

In an aspect, the processor serves as operation state detection unit 202 to detect the operation state of the vehicle equipped with on-vehicle apparatus 200. The operation state is the same as that detected by operation state detection module 110.

In an aspect, the processor serves as surrounding situation acquisition unit 203 to acquire information showing the surrounding situation of the vehicle. The acquired information is the same as the information acquired by surrounding situation acquisition module 130.

In an aspect, the processor serves as on-vehicle control unit 204 to control the operation of on-vehicle apparatus 200.

In an aspect, the processor serves as driving event detection unit 205 to detect the state of the vehicle or the event occurring in the vehicle based on the detected operation state. The detected event is the same as the event detected by the processor serving as driving event detection module 115.

In an aspect, the processor serves as surrounding event detection unit 206 to detect the event occurring around the vehicle. The detected event is the same as the event detected by the processor serving as surrounding event detection module 135.

The processor serves as reaction time measurement unit 207 to calculate the difference between the driver's reaction times as a reaction time based on the time information associated with the detected driving event and the time information associated with the detected surrounding event.

The processor serves as safe driving determination unit 208 to evaluate the driving ability of the vehicle driver based on the calculated reaction time data and the data table prepared in advance for evaluation of the safe driving ability. The data table is stored in advance in a memory of on-vehicle apparatus 200, for example.

The processor serves as result storage unit 209 to store the data about the evaluation. The stored data is the same as the data stored in safe driving ability evaluation result database 180.

User interface unit 210 notifies the user of on-vehicle apparatus 200 about the event detection information or the determination result using a sound or a text message or using light.

[Hardware Configuration of on-Vehicle Apparatus 200]

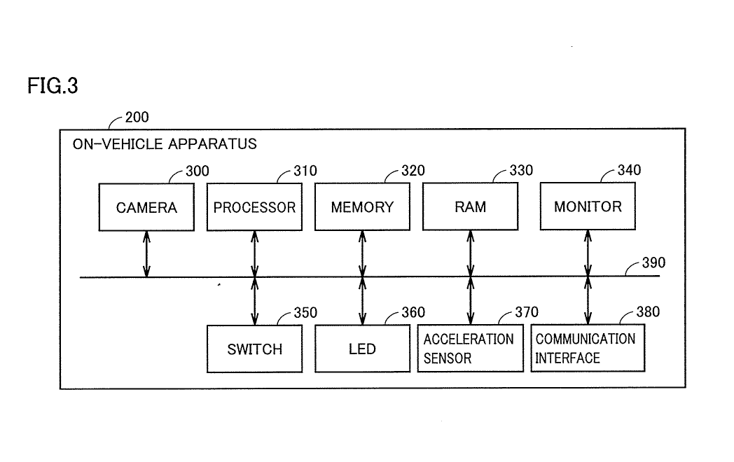

Referring to FIG. 3, the configuration of on-vehicle apparatus 200 will be hereinafter further described. FIG. 3 is a block diagram showing the hardware configuration of on-vehicle apparatus 200. On-vehicle apparatus 200 includes a camera 300, a processor 310, a memory 320, a RAM (Random Access Memory) 330, a monitor 340, a switch 350, an LED 360, an acceleration sensor 370, and a communication interface 380. Each of these components is connected via bus 390.

Camera 300 serves as surrounding situation acquisition unit 203 to take an image of the surrounding area of the vehicle, and output the image data. Processor 310 controls the operation of on-vehicle apparatus 200. Memory 320 stores the data acquired by on-vehicle apparatus 200 or the data input into on-vehicle apparatus 200. RAM 330 temporarily stores the data to be used by processor 310. Monitor 340 serves as user interface unit 210 to display the results of the process by processor 310, the state of on-vehicle apparatus 200 or the like using characters or images.

Switch 350 accepts an operation for changing the operation mode of on-vehicle apparatus 200 or for switching ON and OFF thereof.

LED 360 serves as user interface unit 210 to notify about the result of the process by processor 310, the state of on-vehicle apparatus 200 or the like using light.

Acceleration sensor 370 is configured to detect the acceleration of the vehicle equipped with on-vehicle apparatus 200. Communication interface 380 is configured to input and output a signal for communication between on-vehicle apparatus 200 and another apparatus.

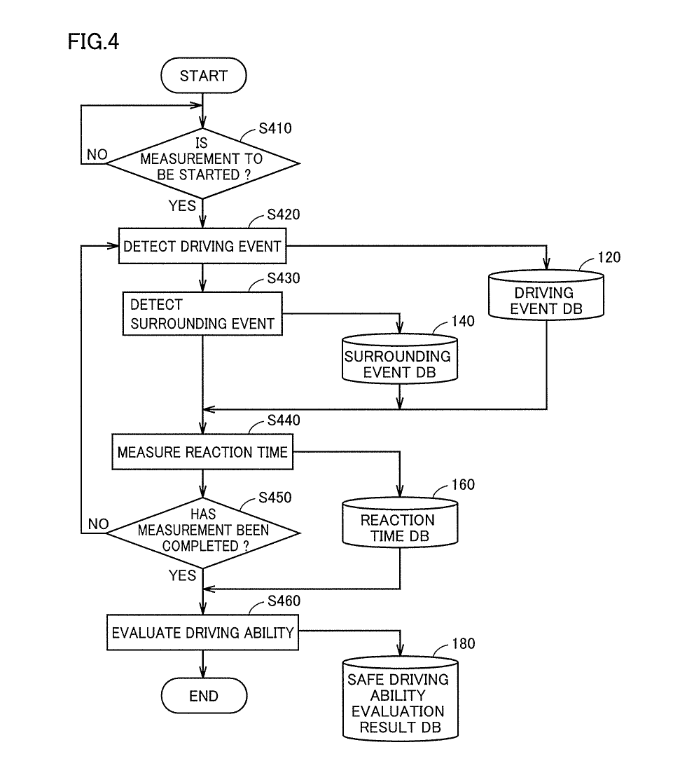

Referring to FIG. 4, the control structure of on-vehicle apparatus 200 according to an embodiment will be hereinafter described. FIG. 4 is a flowchart showing a part of the process executed by processor 310 provided in on-vehicle apparatus 200.

In step S410, processor 310 determines whether measurement is to be started or not. When processor 310 determines that measurement is to be started (YES in step S410), it causes the control to proceed to step S420. If not (NO in step S410), processor 310 return the control to step S410.

In step S420, processor 310 detects a driving event. Processor 310 stores the detected driving event in driving event database 120.

In step S430, processor 310 detects a surrounding event. Processor 310 stores the detected surrounding event in surrounding event database 140.

In step S440, processor 310 measures the reaction time. Processor 310 stores the measured reaction time in reaction time database 160.

In step S450, processor 310 determines whether the measurement has been completed or not. When processor 310 determines that the measurement has been completed (YES in step S450), it causes the control to proceed to step S460. If not (NO in step S450), processor 310 returns the control to step S420.

In step S460, processor 310 evaluates the driver's driving ability. Processor 310 stores the result of the evaluated driving ability in safe driving ability evaluation result database 180. Then, the process ends.

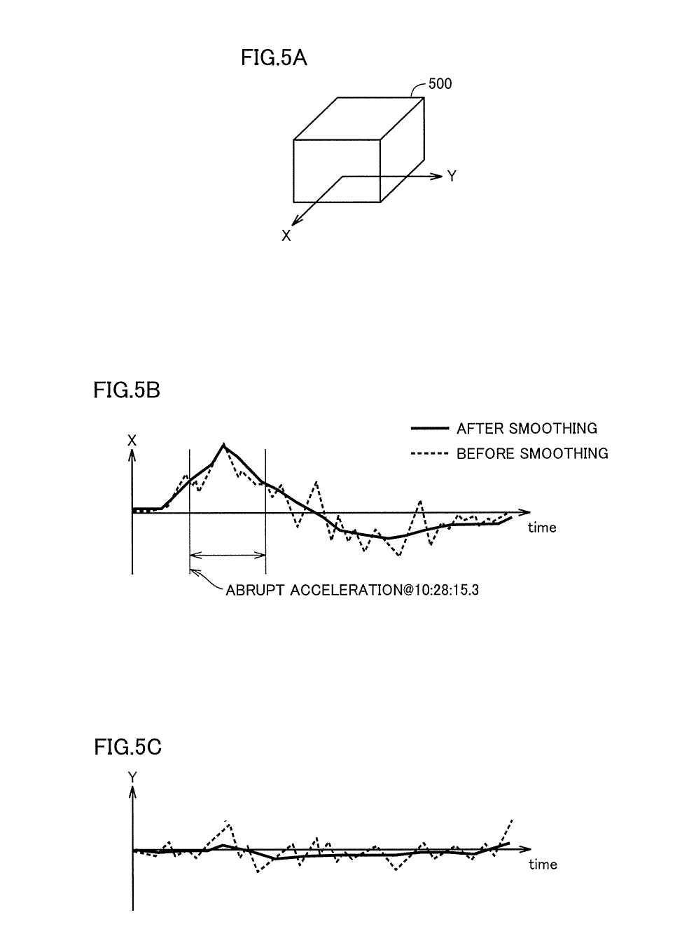

Referring to FIGS. 5A to 5C, detection of the driving event will be hereinafter described. FIGS. 5A to 5C each are a diagram for illustrating the manner in which a driving event is detected in the on-vehicle apparatus according to an embodiment.

FIG. 5A is a diagram conceptually showing the axis of coordinates of a vehicle 500. In an aspect, the acceleration of vehicle 500 in each of the X direction and the Y direction is detected by acceleration sensor 370 serving as driving event detection unit 205. Each detected acceleration is stored in memory 320.

FIG. 5B is a diagram showing values of the acceleration in the X-axis direction that are obtained before and after a smoothing process. FIG. 5C is a diagram showing values of the acceleration in the Y-axis direction that are obtained before and after a smoothing process.

In an aspect, processor 310 performs a smoothing computing process for taking several neighboring sampling values (for example, five in total) as average values, thereby cutting minute oscillating information. Processor 310 derives the acceleration integrated value in a short time (for example, for 1 second). If the derived acceleration integrated value is equal to or greater than a predetermined threshold value, processor 310 determines that an event such as abrupt acceleration, abrupt deceleration, and abrupt operations has occurred. Processor 310 stores the event and the time of occurrence of this event (the start time of integration) in memory 320.

Furthermore, processor 310 derives the acceleration integrated value in a long time (for example, for 5 seconds). When the derived acceleration integrated value is equal to or greater than the predetermined threshold value, processor 310 determines that an event such as acceleration, deceleration or an operation has occurred. Processor 310 stores the event and the time of occurrence of this event (the start time of integration) in memory 320.

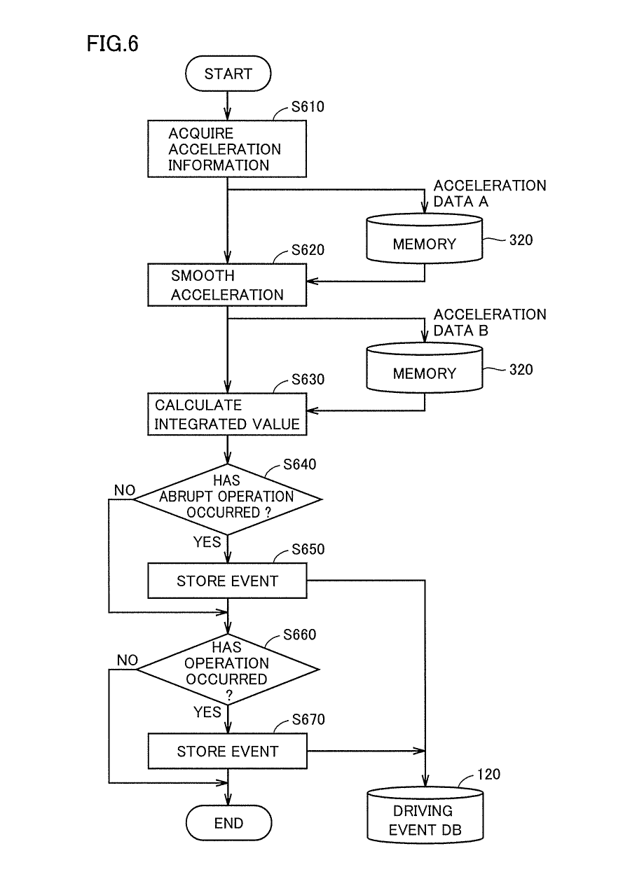

Referring to FIG. 6, the control structure of on-vehicle apparatus 200 will be hereinafter further described. FIG. 6 is a flowchart showing a part of the process executed by processor 310.

In step S610, processor 310 acquires acceleration information. Processor 310 stores the acquired acceleration information as acceleration data A in memory 320.

In step S620, processor 310 smoothes the acceleration. Processor 310 stores the smoothed acceleration as acceleration data B in memory 320.

In step S630, processor 310 calculates an integrated value based on acceleration data B stored in memory 320.

In step S640, processor 310 determines whether an abrupt operation has occurred or not. This determination is made based on whether the calculated acceleration is greater than a predetermined threshold value or not. When processor 310 determines that an abrupt operation has occurred (YES in step S640), it causes the control to proceed to step S650. If not (NO in step S640), processor 310 causes the control to proceed to step S660.

In step S650, processor 310 stores the event in driving event database 120.

In step S660, processor 310 determines whether the operation has occurred or not. This determination is made based on whether the calculated acceleration is greater than a predetermined threshold value or not. When processor 310 determines that an operation has occurred (YES in step S660), it causes the control to proceed to step S670. If not (NO in step S660), processor 310 ends the process.

[Detection of Surrounding Event]

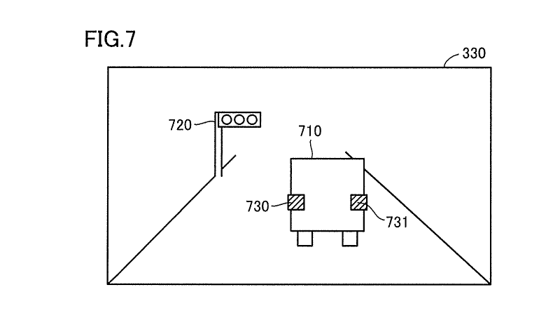

Referring to FIG. 7, detection of the surrounding event by on-vehicle apparatus 200 according to an embodiment will be hereinafter described. FIG. 7 is a diagram conceptually showing a manner of date storage in RAM 330.

In an aspect, a vehicle stores, in RAM 330, an image of the scene in front of this vehicle that has been taken by camera 300. In an aspect, camera 300 takes images of a vehicle 710 running in front of this vehicle, a traffic light 720, and lights 730, 731. The images taken by camera 300 are subjected to image processing performed by processor 310, so as to extract vehicle 710, traffic light 720, and lights 730, 731.

[Process of Detecting Surrounding Event]

On-vehicle apparatus 200 uses camera 300 to acquire the surrounding situation of the vehicle as an image. Through the existing image recognition process, on-vehicle apparatus 200 detects the timing at which the signal has turned red and the brake lamp of the preceding vehicle as “surrounding events”. In addition, the event detected at a position beyond a predetermined distance from the vehicle equipped with on-vehicle apparatus 200 is not regarded as an event for which the reaction time is to be measured. Accordingly, processor 310 does not count the event detected at position beyond a predetermined distance as an event for which the reaction speed is to be measured. Determination as to whether the measurement is to be made or not is made, for example, based on the calculation results obtained using a threshold value calculated in advance on the basis of the object's size and the coordinates on the image. Such a process is performed, for example, in the following flow.

(Step A) Processor 310 stores the information obtained from camera 300 in memory 320.

(Step B) Through the known image recognition process, processor 310 determines whether the event has occurred of not.

(Step C) Processor 310 calculates the distance to the object based on the detection coordinates and the size, to determine whether the reaction time is to be measured for the object.

(Step D) When an event occurs at a distance shorter than the distance of a predetermined threshold value, processor 310 records the event occurrence time on memory 320.

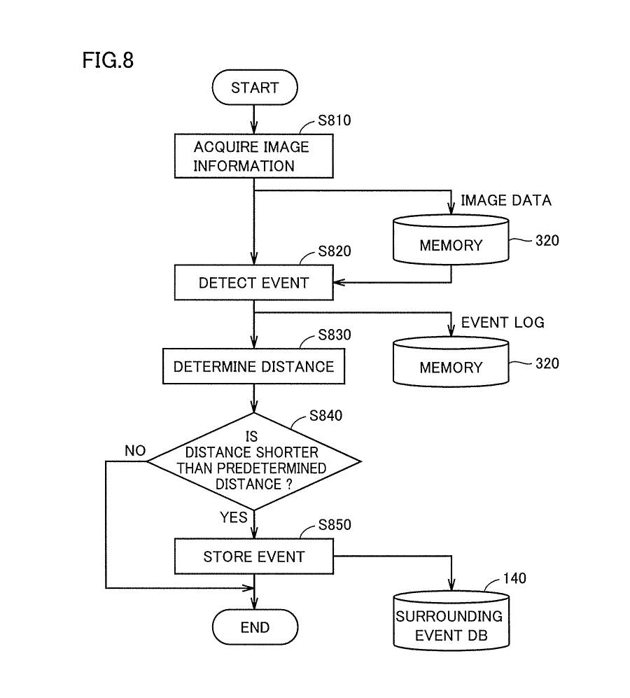

Referring to FIG. 8, the control structure of on-vehicle apparatus 200 will be hereinafter described in detail. FIG. 8 is a flowchart showing a part of the process executed by processor 310.

In step S810, processor 310 acquires image information. Processor 310 stores the acquired image information in memory 320.

In step S820, processor 310 detects an event from the acquired image information. Processor 310 accumulates the detected event as an event log in memory 320.

In step S830, processor 310 determines a distance. The distance includes a distance to a preceding vehicle of the relevant vehicle, for example.

In step S840, processor 310 determines whether this distance is shorter than a predetermined distance or not. When processor 310 determines that the distance is shorter than the predetermined distance (YES in step S840), it causes the control to proceed to step S850. If not (NO in step S840), processor 310 ends the process.

In step S850, processor 310 stores the event in surrounding event database 140.

[Calculation of Reaction Time]

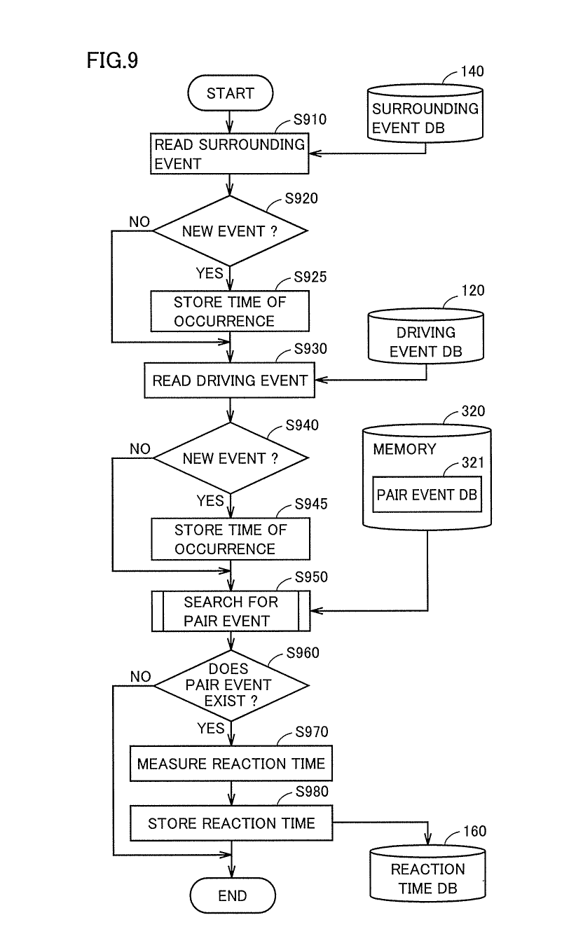

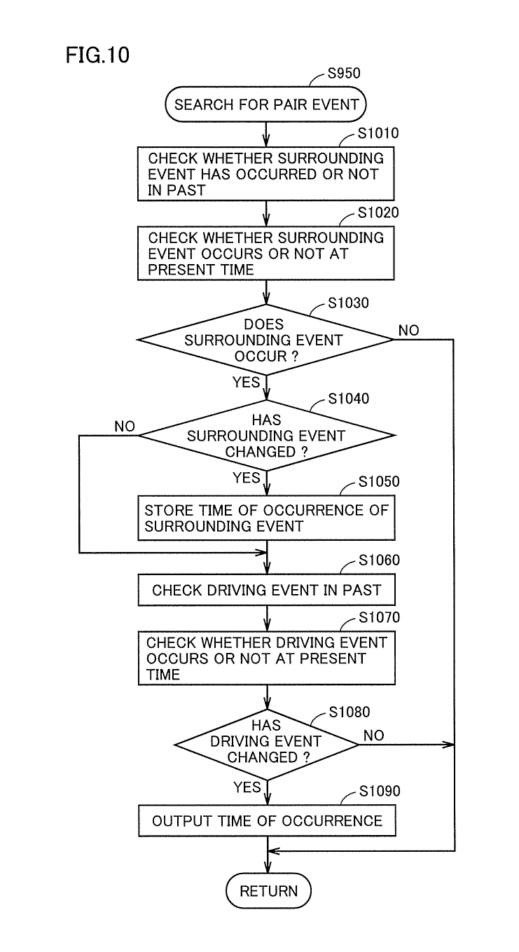

Referring to FIGS. 9 and 10, calculation of the reaction time will be hereinafter described. FIG. 9 is a flowchart showing a part of the process executed by processor 310 for calculating a reaction time, according to an aspect. FIG. 10 is a flowchart showing a part of the process executed by processor 310 for searching for a pair event.

In step S910, processor 310 reads a surrounding event from surrounding event database 140.

In step S920, processor 310 determines whether the read surrounding event is a new event or not. When processor 310 determines that the read surrounding event is a new event (YES in step S920), it cause the control to proceed to step S925. If not (NO in step S920), processor 310 causes the control to proceed to step S930.

In step S925, processor 310 stores the time of occurrence.

In step S930, the processor 310 reads a driving event from driving event database 120.

In step 940, processor 310 determines whether the read driving event is a new event or not. When processor 310 determines that the driving event is a new event (YES in step S940), it causes the control to proceed to step S945. If not (NO in step S940), processor 310 causes the control to proceed to step S950.

In step S945, processor 310 stores the time of occurrence.

In step S950, processor 310 performs a pair event searching process, which will be described later. When this process is performed, the pair event is searched from a pair event database 321 in memory 320.

In step S960, processor 310 determines whether the pair event exists or not in pair event database 321. When processor 310 determines that the pair event exists in pair event database 321 (YES in step S960), it causes the control to proceed to step S970. If not (NO in step S960), processor 310 ends the process.

In step S970, processor 310 measures a reaction time.

In step S980, processor 310 stores the measured reaction time in reaction time database 160. Then, the process ends.

Referring to FIG. 10, in step S1010, processor 310 checks whether a surrounding event has occurred or not in the past.

In step S1020, processor 310 checks whether a surrounding event occurs or not at the present time.

In step S1030, processor 310 determines whether a surrounding event occurs or not. When processor 310 determines that the surrounding event occurs (YES in step S1030), it causes the control to proceed to step S1040. If not (NO in step S1030), processor 310 ends the process.

In step S1040, processor 310 determines whether the surrounding event has changed or not. When processor 310 determines that the surrounding event has changed (YES in step S1040), it causes the control to proceed to step S1050. If not (NO in step S1040), processor 310 causes the control to proceed to step S1060.

In step S1050, processor 310 stores the time of occurrence of the surrounding event. In step S1060, processor 310 checks a driving event in the past.

In step S1070, processor 310 checks whether the driving event occurs or not at the present time.

In step S1080, processor 310 determines whether the driving event has changed or not. When processor 310 determines that the driving event has changed (YES in step S1080), it causes the control to proceed to step S1090. If not (NO in step S1080), processor 310 ends the process.

In step S1090, processor 310 outputs the time of occurrence.

[Data Structure]

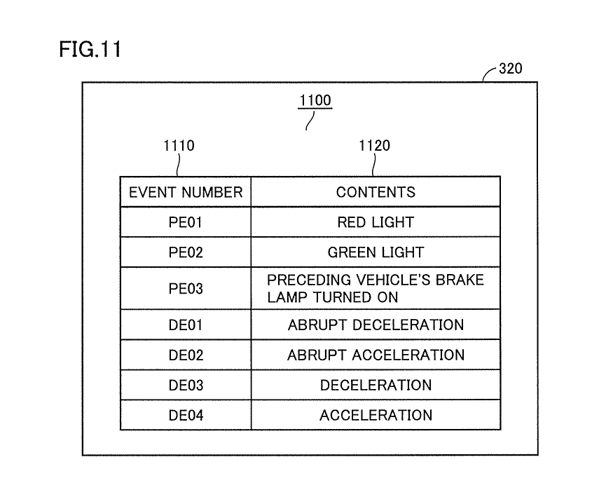

Referring to FIG. 11, the data structure of on-vehicle apparatus 200 according to an embodiment will be hereinafter described. FIG. 11 is a diagram conceptually showing a manner of data storage in memory 320.

In an aspect, memory 320 includes a table 1100. Table 1100 includes an event number 1110 and contents 1120.

Event number 1110 is used for identifying a surrounding event (PE) or a driving event (DE). Contents 1120 show a surrounding event of the vehicle (for example, a red light, a green light, and the like) and an event showing the state of the running vehicle (for example, abrupt deceleration, abrupt acceleration, and the like).

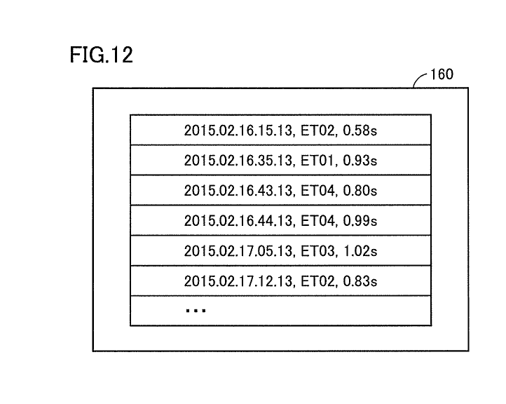

Referring to FIG. 12, the data structure of system 100 will be hereinafter described. FIG. 12 is a diagram conceptually showing a manner of data storage in reaction time database 160.

In an aspect, reaction time database 160 includes accumulation of date and time data, event data, and reaction time. The date and time data shows the date and the time at which the event was detected. The event data shows the detected event. The reaction time shows a reaction time measured by reaction time measurement module 150.

[Data Structure]

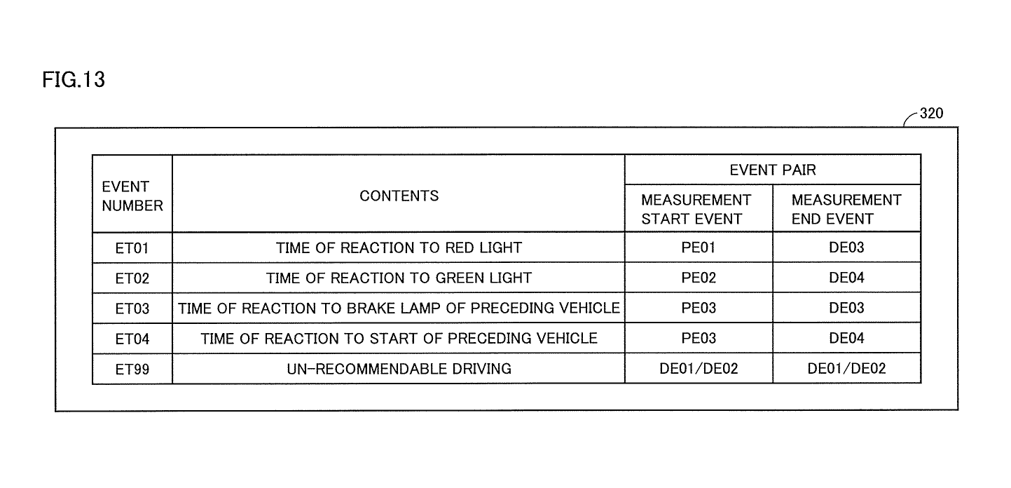

Referring to FIG. 13, the data structure of on-vehicle apparatus 200 according to an embodiment will be hereinafter described. FIG. 13 is a diagram conceptually showing a manner of data storage in memory 320.

Memory 320 includes an event number, contents, and an event pair. The event pair includes a measurement start event and a measurement end event.

The event number is used for identifying the contents of the reaction to the event. The contents show contents (types) of the reaction to the event (for example, the time of reaction to a signal or a brake lamp; a distinction between recommendable driving and un-recommendable driving; and the like). The measurement start event is used for identifying the event that triggers the start of measurement. The measurement end event is used for identifying the event detected when the measurement is ended.

[Driving Ability Evaluation]

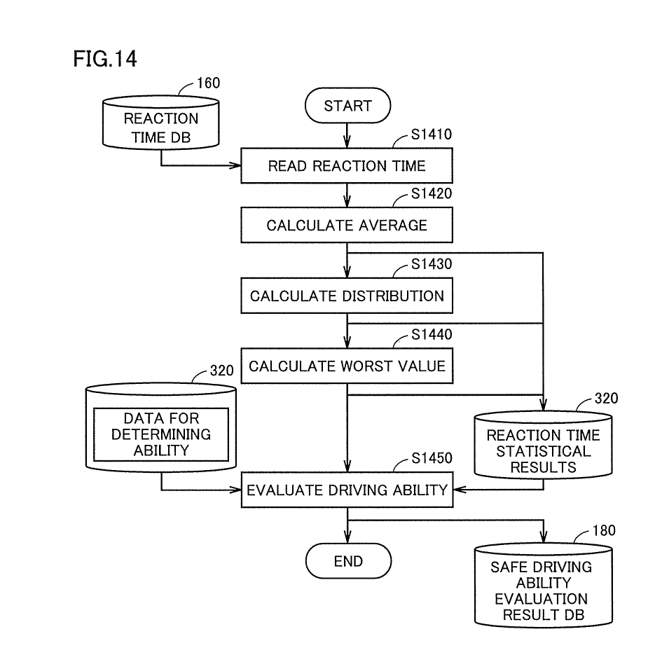

Referring to FIG. 14, the driving ability evaluation will be hereinafter described. FIG. 14 is a flowchart showing a part of the process executed by processor 310 for evaluating the driving ability of a vehicle driver.

In step S1410, processor 310 reads a reaction time from reaction time database 160.

In step S1420, processor 310 calculates an average value.

Processor 310 stores the calculated average value as a reaction time statistical result in memory 320.

In step S1430, processor 310 calculates a distribution from the calculated average value.

Processor 310 stores the calculated distribution in memory 320.

In step S1440, processor 310 calculates the worst value from among the calculated distribution. Processor 310 stores the calculated worst value as a reaction time statistical result in memory 320.

In step S1450, processor 310 evaluates the driver's driving ability based on the data for determining a driving ability and the reaction time statistical results that are stored in memory 320. Processor 310 stores the evaluated driving ability in safe driving ability evaluation result database 180.

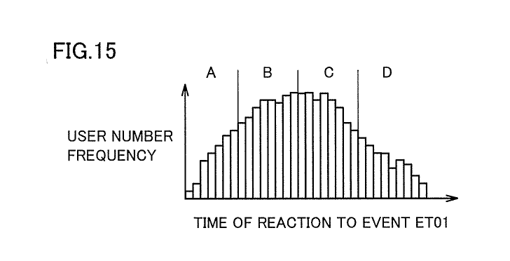

Referring to FIG. 15, the distribution of the reaction times will be hereinafter described. FIG. 15 is a diagram showing an image of a distribution of the reaction times relative to an event ET01.

In an aspect, processor 310 derives a distribution from the average, the distribution, the worst value and the like of a plurality of drivers' reaction times relative to each event. Processor 310 gives a good evaluation to a user exhibiting a relatively fast reaction time (for example, evaluation A) and gives a bad evaluation to a user exhibiting a relatively slow reaction time (for example, evaluation D).

[Evaluation Results]

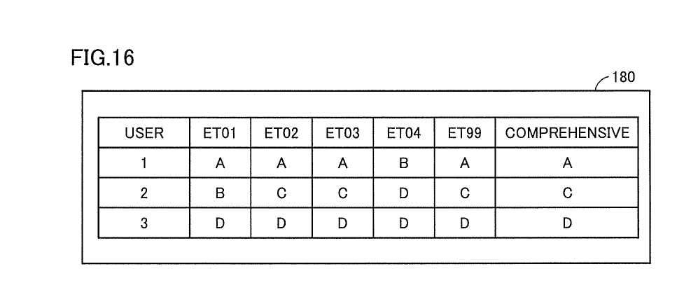

Referring to FIG. 16, the data structure of system 100 will be hereinafter further described. FIG. 16 is a diagram conceptually showing a manner of data storage in safe driving ability evaluation result database 180. Safe driving ability evaluation result database 180 is implemented, for example, in a server device managed by the business operator (for example, a vehicle insurance company) making an evaluation about safe driving using on-vehicle apparatus 200. The server device is implemented by a computer having a well-known configuration. Therefore, the detailed description of the server device will not be repeated.

In an aspect, safe driving ability evaluation result database 180 stores a user ID (Identification), evaluations based on the reaction time for each event, and comprehensive evaluations based on the reaction time to each event. The business operator can refer to such evaluation values to assign weights to the service provided by the business operator. For example, the business operator can set the insurance fee in accordance with the evaluation values.

As described above, according to an embodiment, the driver's safe driving ability can be determined by measuring the time period from the timing of occurrence of a change in the surrounding situation to be reflected in the driving behavior until the time when the driver responds to the change, makes a determination and performs an operation therefor.

Thus, the driving ability can be visualized by measuring the reaction time from occurrence of the surrounding event until the driver performs an operation in response to the surrounding event, and based on this reaction time, evaluating the driving ability deterioration due to aging or poor health that cannot be determined only by the driving roughness such as abrupt operations, abrupt acceleration, or abrupt deceleration. For example, in the case where the driver notices lighting-ON of a brake lamp of the preceding vehicle, and then slowly applies a brake to stop the vehicle, (i) if the reaction speed is relatively fast, it may be determined that safe driving is performed with a sufficient distance maintained between the vehicles; however, (ii) if the reaction speed is relatively slow, there may be a dangerous driving operation, for example, the driver's vehicle suddenly approaches its preceding vehicle. According to on-vehicle apparatus 200 in an embodiment, it can be determined that the slow reaction speed due to the driver's poor health or aging leads to deterioration in safe driving ability.

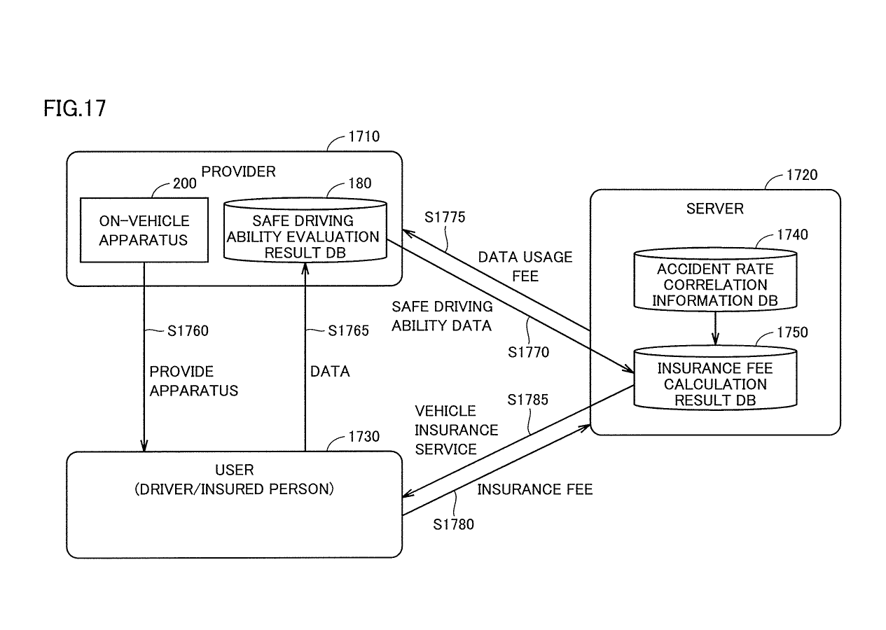

Referring to FIG. 17, a practical example using on-vehicle apparatus 200 according to an embodiment will be hereinafter described. FIG. 17 is a diagram showing the relation between a person concerned who uses data obtained by on-vehicle apparatus 200 and the data.

In an aspect, a provider 1710 has an on-vehicle apparatus 200 and a safe driving ability evaluation result database 180.

The vehicle insurance company manages a server 1720. Server 1720 is implemented as a computer device having a well-known configuration, as will be described later. Server 1720 includes an accident rate correlation information database 1740 and an insurance fee calculation result database 1750.

As a driver or an insured person, a user 1730 is provided with on-vehicle apparatus 200 from provider 1710 or receives insurance service from the vehicle insurance company.

More specifically, in step S1760, provider 1710 provides on-vehicle apparatus 200 to user 1730.

In step S1765, user 1730 provides provider 1710 with data acquired by use of on-vehicle apparatus 200. The provided data is accumulated, for example, in safe driving ability evaluation result database 180.

In step S1770, provider 1710 reads the safe driving ability data from safe driving ability evaluation result database 180, and transmits the read data to server 1720 of the vehicle insurance company. The transmitted data is stored, for example, in insurance fee calculation result database 1750.

In step S1775, the vehicle insurance company pays a data usage fee to provider 1710 in response to reception of the safe driving ability data from provider 1710.

In step S1780, user 1730 pays an insurance fee to the vehicle insurance company. The payment information is accumulated in server 1720 of the vehicle insurance company.

In step S1785, the vehicle insurance company provides vehicle insurance service to user 1730. The insurance fee of this service provided at this time is calculated, for example, based on the data stored in insurance fee calculation result database 1750.

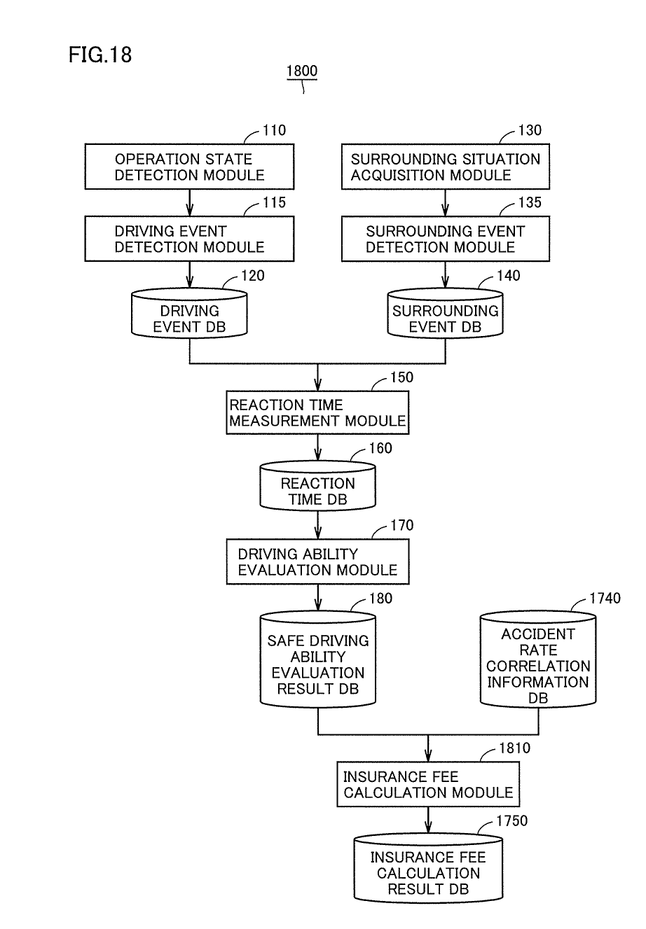

Referring to FIG. 18, the configuration of a system 1800 according to another aspect will be hereinafter described. FIG. 18 is a diagram showing an example of the configuration of system 1800. System 1800 additionally includes an accident rate correlation information database 1740, an insurance fee calculation module 1810, and an insurance fee calculation result database 1750 in a configuration of system 100 shown in FIG. 1.

In an embodiment, the accident rate correlation information including the causal relation of the accident rate is further used. Insurance fee calculation module 1810 automatically calculates a vehicle insurance fee.

[Derivation of Accident Rate Correlation Information]

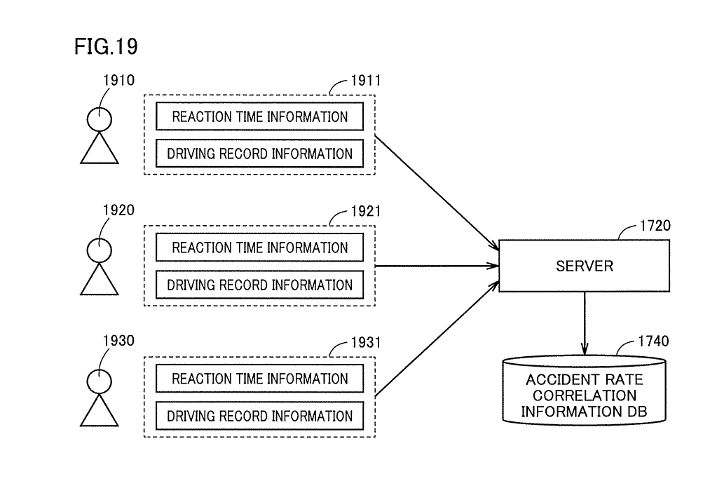

Referring to FIG. 19, derivation of the accident rate correlation information will be hereinafter described. FIG. 19 is a diagram showing a manner in which reaction time information and driving record information obtained from a plurality of users are sent to server 1720 of the vehicle insurance company.

In an aspect, server 1720 collects reaction time information obtained from on-vehicle apparatus 200 used by a plurality of users, and driving record information including a summary of occurrence or nonoccurrence of accidents and the like during a time period in which a vehicle equipped with on-vehicle apparatus 200 travels. Server 1720 derives the characteristics of the reaction time and the causal relation of the accident rate through known statistical processing, thereby calculating an insurance fee in accordance with the characteristics of the reaction time.

For example, a user 1910 uses an on-vehicle apparatus 1911 having the same function as that of on-vehicle apparatus 200. On-vehicle apparatus 1911 transmits, to server 1720, the reaction time information and the driving record information obtained by user 1910 driving the vehicle. The transmission timing is not particularly limited. The reaction time information and the driving record information may be transmitted from on-vehicle apparatus 1911 to server 1720 at each time interval set in advance, for example, every hour, every day, every week, every month, or the like. In another aspect, when user 1910 gives a transmission instruction to on-vehicle apparatus 1911, on-vehicle apparatus 1911 transmits the reaction time information and the driving record information to server 1720. Server 1720 of the vehicle insurance company stores the received information in accident rate correlation information database 1740.

User 1920 uses an on-vehicle apparatus 1921 having the same function as that of on-vehicle apparatus 200. On-vehicle apparatus 1921 transmits, to server 1720, the reaction time information and the driving record information obtained by user 1920 driving the vehicle.

User 1930 uses an on-vehicle apparatus 1931 having the same function as that of on-vehicle apparatus 200. On-vehicle apparatus 1931 transmits, to server 1720 in the vehicle insurance company, the reaction time information and the driving record information obtained by user 1930 driving the vehicle. The transmitted data is stored in accident rate correlation information database 1740.

Although three users are shown in the example shown in FIG. 19, the number of users is not limited thereto. A lot more users may use similar on-vehicle apparatuses 200, and the reaction time information and the driving record information may be transmitted to server 1720.

[Summary]

According to an embodiment, not only the reaction time information but also the driving record information including occurrence or nonoccurrence of accidents is used. Accordingly, a potential accident risk can be derived from the reaction time characteristics. Consequently, it becomes possible to calculate an accident risk with accuracy higher than that achieved in the current insurance system in which the insurance fee is calculated using ages, a traveling distance, and abrupt or slow acceleration.

Another aspect of an embodiment will be hereinafter described. Another aspect is different from the aspect in the above-described embodiment in that the measurement accuracy of the reaction time is improved in consideration of the driving state.

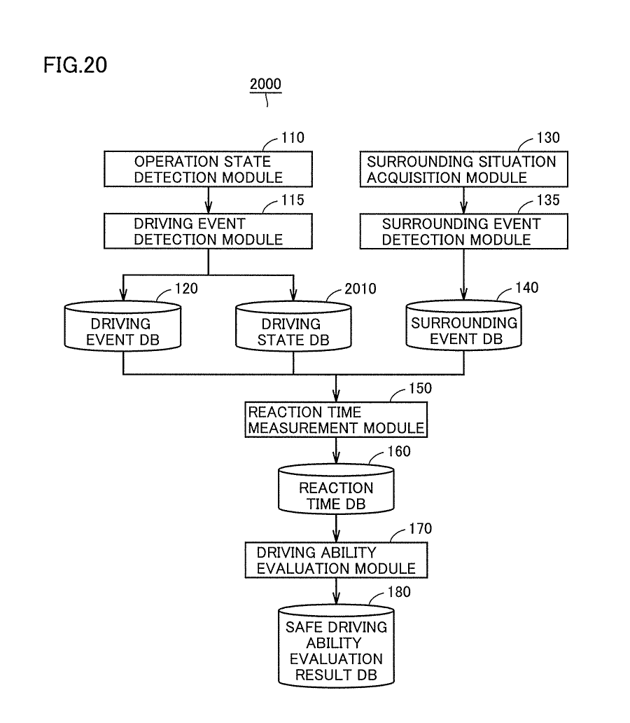

Referring to FIG. 20, the configuration of a system 2000 will be hereinafter described. FIG. 20 is a diagram conceptually showing the configuration of system 2000 according to an embodiment.

In addition to the configuration of system 100 shown in FIG. 1, system 2000 further includes a driving state database 2010. Driving state database 2010 stores the current vehicle state. Driving state database 2010 is stored in on-vehicle apparatus 200 or an external server (for example, server 1720 in the vehicle insurance company).

[Data Structure]

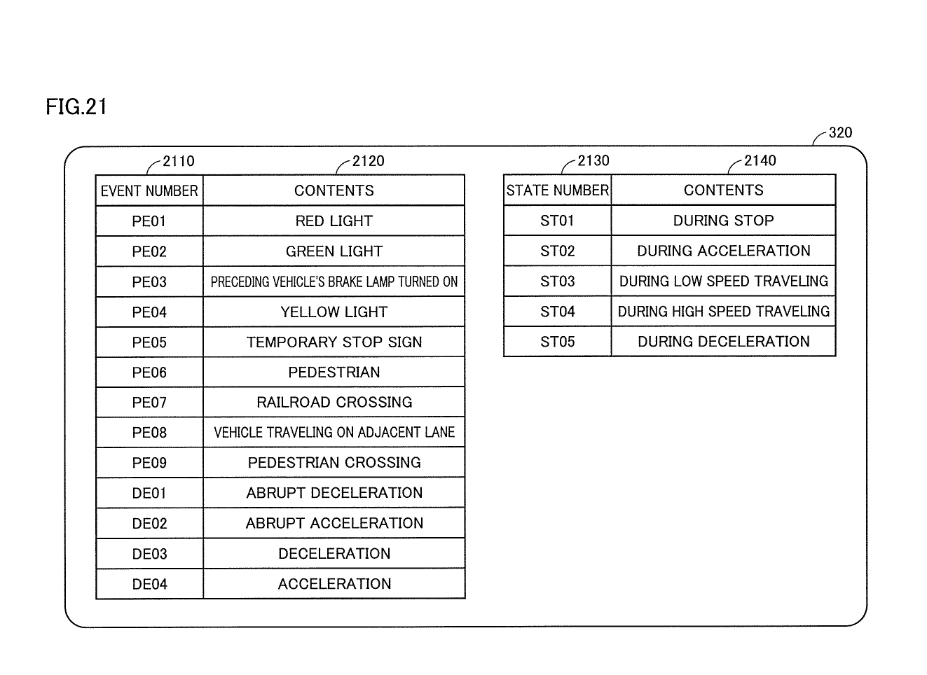

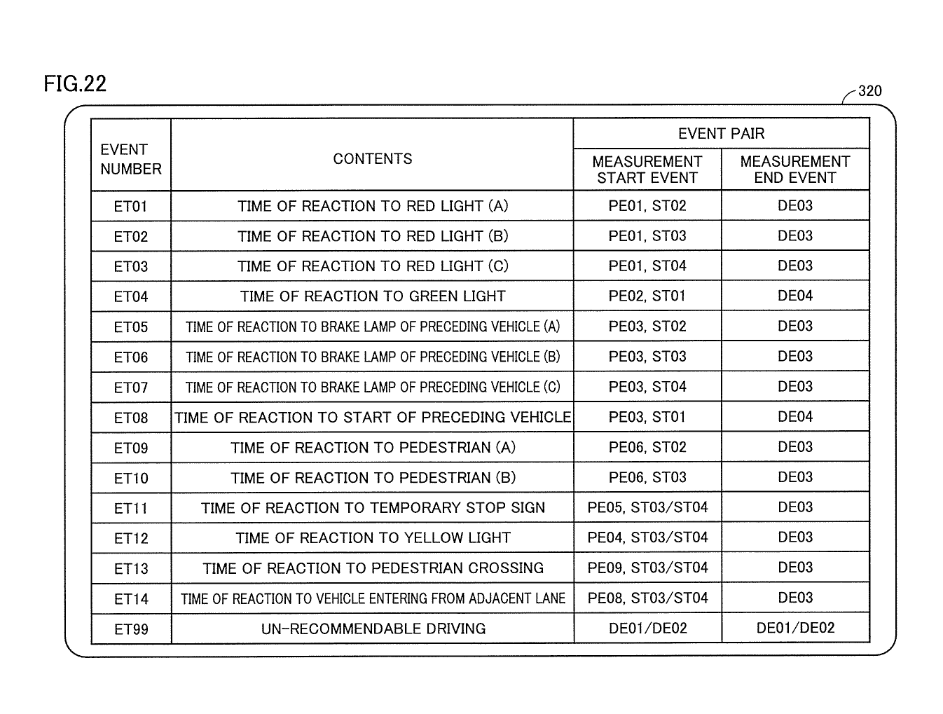

Referring to FIGS. 21 and 22, the data structure of system 2000 will be hereinafter described. FIG. 21 is a diagram conceptually showing a manner of data storage in memory 320 that implements system 2000. FIG. 22 is a diagram showing event pairs.

Memory 320 stores an event number 2110, contents 2120, a state number 2130, and contents 2140. Event number 2110 is used for identifying an event.

Contents 2120 are used for identifying the contents corresponding to an event. State number 2130 is used for identifying the state of the vehicle. Contents 2140 are used for identifying the contents corresponding to the state of the vehicle.

Referring to FIG. 22, memory 320 stores an event number, contents, and an event pair. The event pair includes a measurement start event and a measurement end event.

The event number is used for identifying an event. The contents show the reaction that may be taken by a driver in response to a surrounding event. The measurement start event shows an event that triggers the start of measurement of the reaction time. The measurement start event includes a surrounding event (PE) and a state event (ST). The measurement end event shows an event that triggers the end of measurement of the reaction time.

As described above, according to an embodiment, the types of the vehicle state and the event are increased, thereby improving the accuracy of the reaction time measurement results as data used for determining the safe driving ability. For example, the reaction time taken when the preceding vehicle's driver applies a brake is different between low-speed vehicle traveling and high-speed vehicle traveling. Since the distance between the vehicles is not abruptly reduced during low-speed vehicle traveling, a collision is less likely to occur even if the driver of the following vehicle takes a relatively long time to press a brake pedal. On the other hand, during high-speed vehicle traveling, if the driver cannot quickly make a response when the preceding vehicle's driver presses a brake pedal, a collision is more likely to occur. Thus, a driving situation is specifically subdivided for measuring a reaction time, so that it can be more accurately determined whether the driver's decision shown in each driving event is correct or not.

Another aspect of an embodiment will be hereinafter described. The present aspect is different from the above-described aspect in that a driving event is detected from the information obtained by the surrounding situation detection unit like a camera.

In an aspect, a driving event may be detected from images obtained by camera 300 by using the vehicle behavior estimation technique referred to as “ego-motion” that is a known technique.

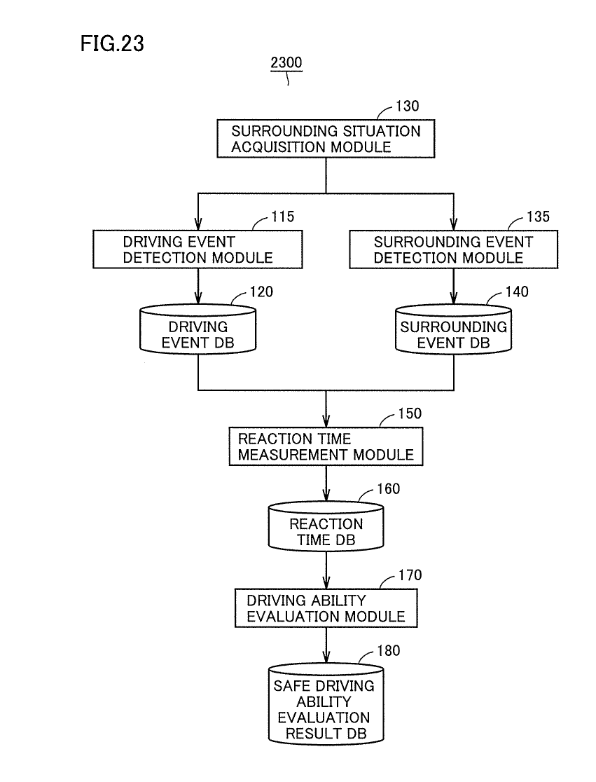

Referring to FIG. 23, the configuration of a system 2300 according to an embodiment will be hereinafter described. FIG. 23 is a diagram conceptually showing the configuration of system 2300. System 2300 has a configuration of system 100 shown in FIG. 1 excluding operation state detection module 110.

Driving event detection module 115 detects a driving event based on the surrounding situation acquired by surrounding situation acquisition module 130. In an embodiment, surrounding situation acquisition module 130 is implemented by camera 300.

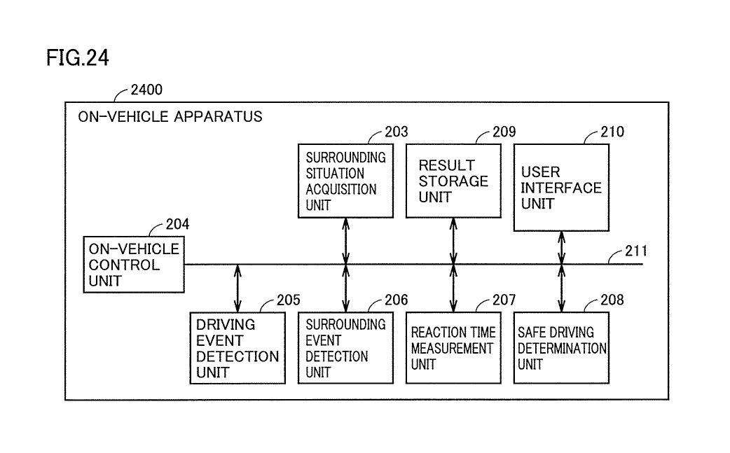

Referring to FIG. 24, the configuration of an on-vehicle apparatus 2400 will be hereinafter described. FIG. 24 is a diagram showing the configuration of on-vehicle apparatus 2400.

On-vehicle apparatus 2400 has a configuration of on-vehicle apparatus 200 shown in FIG. 2 excluding operation state detection unit 202. Since other configurations are the same as those of on-vehicle apparatus 200 shown in FIG. 2, the detailed description thereof will not be repeated.

As described above, according to an embodiment, since only a camera has to be provided as a sensor, components for detecting a driving event are not required. Consequently, the cost for on-vehicle apparatus 200 can be reduced.

Another aspect of an embodiment will be hereinafter described. In another aspect, a surrounding event may be detected not by using a sensor such as a camera but by using communication between vehicles, communication between a vehicle and an infrastructure, and communication between a vehicle and a pedestrian, in which case each communication is transmitted from an object to be detected. For example, a surrounding event may be detected by a wireless device in place of surrounding situation acquisition module 130.

In an aspect, a traffic light and a road sign may submit/show information that is used for detecting a surrounding event. For example, a traffic light is equipped with a transmitter for transmitting a signal including its position information in advance. For example, each time a signal changes, the transmitter transmits this signal. When a vehicle receives the signal, it recognizes that the traffic signal has changed from green to yellow, from yellow to red, or from red to green. On-vehicle apparatus 200 may detect a surrounding event based on this recognition.

In another example, the road sign placed at an intersection includes a transmitter for transmitting a signal including the present address. This transmitter is configured to transmit a signal, for example, in a fixed direction on the road. When a vehicle or on-vehicle apparatus 200 receives this signal, it may detect that the vehicle is approaching the intersection. On-vehicle apparatus 200 may determine the degree of safe driving in consideration of this detection result.

According to an embodiment, the existence or absence of an object to be detected for a surrounding event can be determined irrespective of the accuracy of image recognition. Accordingly, it becomes possible to technically readily maintain a relatively high accuracy for measuring the reaction time.

Then, the technical idea according to another aspect will be hereinafter described. According to the technical idea, an apparatus mounted in a vehicle or another information processing unit that receives information from this apparatus produces ideal driving event information based on the surrounding event information, and determines whether this ideal driving event information matches with the actual driving event or not, thereby measuring the driver's safe driving ability. The apparatus mounted in a vehicle (which will be hereinafter simply referred to as an “on-vehicle apparatus”) includes a processor, a memory, and an input/output interface. The information processing unit is implemented, for example, by a computer system having a well-known configuration.

For example, the on-vehicle apparatus serves as a surrounding situation acquisition unit to acquire information about the distance from the sensor mounted in the vehicle to the moving image data or an obstacle around the vehicle. The on-vehicle apparatus serves as a surrounding event detection unit to detect surrounding events such as the existence or absence of a signal, the state of the signal (a green light, a yellow light, a red light, and the like), the existence or absence of a preceding vehicle, ON or OFF of a brake lamp of a preceding vehicle, the existence or absence of a pedestrian, and the like. Then, the on-vehicle apparatus stores them as surrounding events together with the time of detection of each of these surrounding events. Then, the on-vehicle apparatus serves as an ideal driving generation unit to generate ideal driving event data about acceleration, deceleration, right turns, left turns, and the like that should be executed according to traffic rules at the time of occurrence of the above-described surrounding event. Furthermore, the on-vehicle apparatus serves as an operation state detection unit to acquire information such as speed, acceleration and the like from the sensor mounted in the vehicle. The on-vehicle apparatus serves as a driving event detection unit to detect actual driving events such as acceleration, deceleration, right turns and left turns, and then, store them as driving event data together with the time of detection of each event. Furthermore, the on-vehicle apparatus compares the ideal driving event data with the detected actual driving event data, determines the driver's safe driving ability based on the difference, and generates the safe driving ability evaluation results about the driver.

[System Configuration]

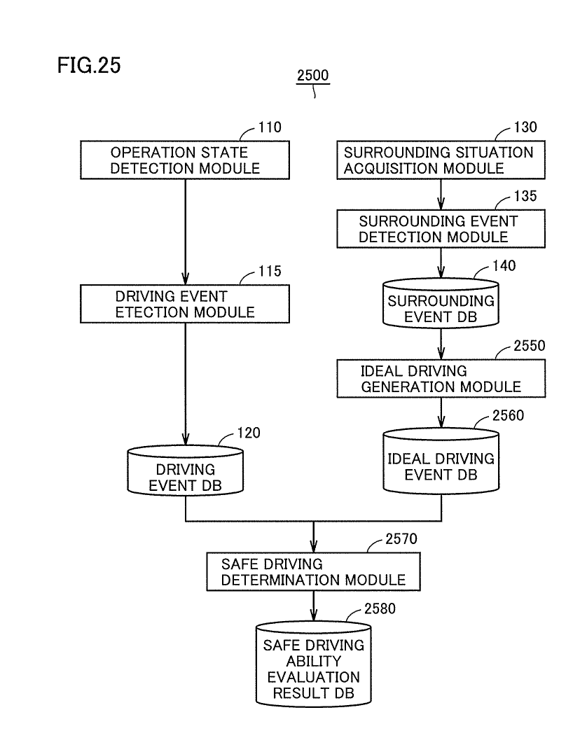

Referring to FIG. 25, the configuration of a system 2500 will be hereinafter described. FIG. 25 is a block diagram showing the configuration of functions implemented by system 2500.

In an aspect, system 2500 includes an operation state detection module 110, a driving event detection module 115, a driving event database 120, a surrounding situation acquisition module 130, a surrounding event detection module 135, a surrounding event database 140, an ideal driving generation module 2550, an ideal driving event database 2560, a safe driving determination module 2570, and a safe driving ability evaluation result database 2580.

Operation state detection module 110 is configured to detect the operation state of the vehicle (for example, an automobile) by the user (a driver) who receives service from the system. The operation state for example includes: the degree of pressing an accelerator pedal by the user; the traveling speed of a vehicle, the operating state of an ABS (Anti-lock Brake System), time, engine rotation speed and changes in the engine rotation speed, setting of an automatic transmission (parking, reverse, neutral, drive, and the like), the use status of a turn signal lamp, the use status of a car-navigation system, the ON/OFF status of a headlamp, the use status of an air-conditioner, and the like. Operation state detection module 110 accepts the input of a signal showing the operation state from each sensor or each apparatus mounted in a vehicle. Furthermore, operation state detection module 110 may detect the degree of acceleration or deceleration based on the signal output from the acceleration sensor. Furthermore, operation state detection module 110 may detect the current position of the vehicle using a GPS (Global Positioning System). Operation state detection module 110 includes, for example, a camera, a laser radar, an acceleration sensor, and the like.

Driving event detection module 115 is configured to detect the vehicle state or the event occurring in the vehicle based on the operation state detected by operation state detection module 110. For example, the event may include acceleration, deceleration, left turns, right turns, ON and OFF of a light, and the like. Driving event detection module 115 associates the detected event with the time of detection of the event, and stores the associated results in driving event database 120.

Driving event database 120 may be implemented as a hard disk of a computer constituting system 2500 or, in another aspect, as an external storage device connected to the computer.

Surrounding situation acquisition module 130 is configured to acquire the surrounding situation of the vehicle. The surrounding situation is expressed, for example, by moving image data around the vehicle (for example, front, rear, right, left, and the like) or as information of the distance between the vehicle and an obstacle, that is detected by a sensor.

Surrounding event detection module 135 is configured to detect an event occurring around the vehicle. This event includes, for example, the existence or absence of a signal, the state of the signal, the existence or absence of a preceding vehicle, ON or OFF of a brake lamp, the existence or absence of a pedestrian, and the like.

Surrounding event database 140 is configured to associate the event detected in surrounding event detection module 135 with the time of detection of this event, and stores the associated result.

Ideal driving generation module 2550 is configured to refer to surrounding event database 140 to generate a data set that shows ideal driving events such as acceleration, deceleration, right turns, and left turns that should be carried out according to traffic rules when the above-described surrounding event occurs. This data set may for example include: the data showing the contents of events (acceleration, deceleration, right turns, left turns, and the like); and the data showing the timing at which each event should be performed. In an embodiment, the ideal driving means that abrupt operations like abrupt acceleration, abrupt deceleration and an abrupt steering wheel operation are not performed during a driving operation such as an accelerator operation, a brake operation, or a steering wheel operation. The condition that abrupt operations are not performed means that such operations are performed at an acceleration rate of a predetermined value or less or at a steering-wheel rotation speed of a predetermined value or less. For example, in an aspect, when the signal turns green and the vehicle starts to move, the driver presses an accelerator pedal at a predetermined time change rate or less. Such an accelerator operation can be regarded as an ideal driving state. In another aspect, when the signal turns red, the driver presses a brake pedal at a change rate of a predetermined value or less. Such a brake operation can be regarded as an ideal driving state. In still another aspect, when the driver changes a lane, the driver turns a steering wheel to the right or the left at a predetermined rotation speed or less. Such a steering wheel operation can be regarded as an ideal driving state.

Ideal driving event database 2560 is configured to store the ideal driving event generated by ideal driving generation module 2550.

Safe driving determination module 2570 is configured to evaluate the driving ability of the vehicle's driver based on the actual driving event stored in driving event database 120 and the ideal driving event stored in ideal driving event database 2560. For example, safe driving determination module 2570 calculates the difference between the time data associated with the actual driving event (for example, the time period actually measured from the red light until start of deceleration) and the time data associated with the ideal event (for example, the ideal time period from the above-mentioned red light until start of deceleration). Based on whether this difference falls within a predetermined reference range or not, safe driving determination module 2570 determines whether the actual driving event is safe driving or not.

Safe driving ability evaluation result database 2580 is configured to store the data about the evaluation performed by safe driving determination module 2570. For example, safe driving ability evaluation result database 2580 is configured to store: driving events and ideal driving events; information of the time of occurrence of each of these events; data of the reaction time taken from occurrence of each of these events until execution of the vehicle operation; safe driving ability evaluation results; and the like.

In an aspect, system 2500 is implemented by an apparatus mounted in a vehicle (which will be hereinafter also referred to as an “on-vehicle apparatus”) and a computer system receiving data from the on-vehicle apparatus. The computer system has a well-known configuration, and at least includes a keyboard and other input devices, a monitor and other output devices, a hard disk, a RAM (Random Access Memory) and other storage devices, and a computing device like a CPU (Central Processing Unit). Since the configuration of such a computer system is well known, further detailed explanation thereof will not be repeated. In another aspect, the processes performed by the above-mentioned computer system may be performed while being distributed in cloud computer systems arranged at a plurality of points.

In still another aspect, all of the above-described processes may be implemented in an on-vehicle apparatus.

[Configuration of on-Vehicle Apparatus 2600]

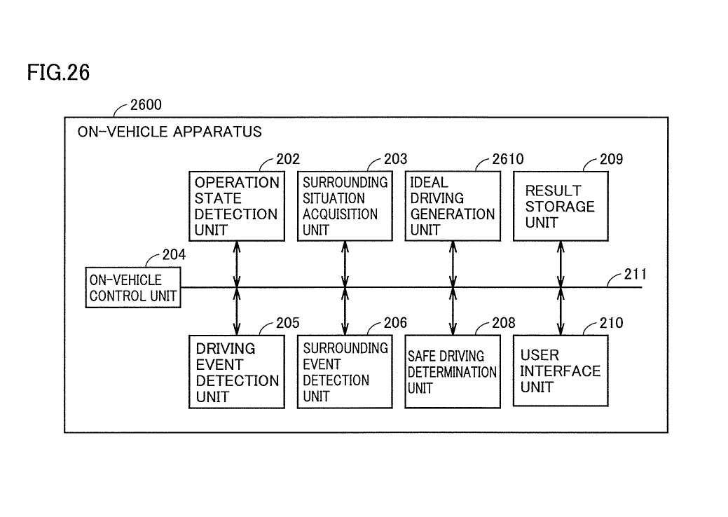

Referring to FIG. 26, an on-vehicle apparatus 2600 according to an embodiment will be hereinafter described. FIG. 26 is a block diagram showing part of components implementing on-vehicle apparatus 2600.

On-vehicle apparatus 2600 includes an operation state detection unit 202, a surrounding situation acquisition unit 203, an on-vehicle control unit 204, a driving event detection unit 205, a surrounding event detection unit 206, an ideal driving generation unit 2610, a safe driving determination unit 208, a result storage unit 209, and a user interface unit 210. Each of the components is connected to a control bus 211. In addition, the same components as those shown in FIG. 2 are designated by the same reference characters. Therefore, the description thereof will not be repeated.

Based on the surrounding event detected by surrounding event detection unit 206, ideal driving generation unit 2610 generates ideal driving event data such as acceleration, deceleration, right turns, left turns, and the like that should be performed according to traffic rules. The ideal driving event data may include the data used for identifying an event, and the data describing the driving contents associated with the event.

[Hardware Configuration of on-Vehicle Apparatus 2600]

In an aspect, on-vehicle apparatus 2600 may be implemented by the same hardware as that of on-vehicle apparatus 200. Therefore, the description of the hardware configuration of on-vehicle apparatus 2600 will not be repeated. Thus, when the hardware configuration of on-vehicle apparatus 2600 is hereinafter mentioned, the hardware configuration shown in FIG. 3 is to be applied.

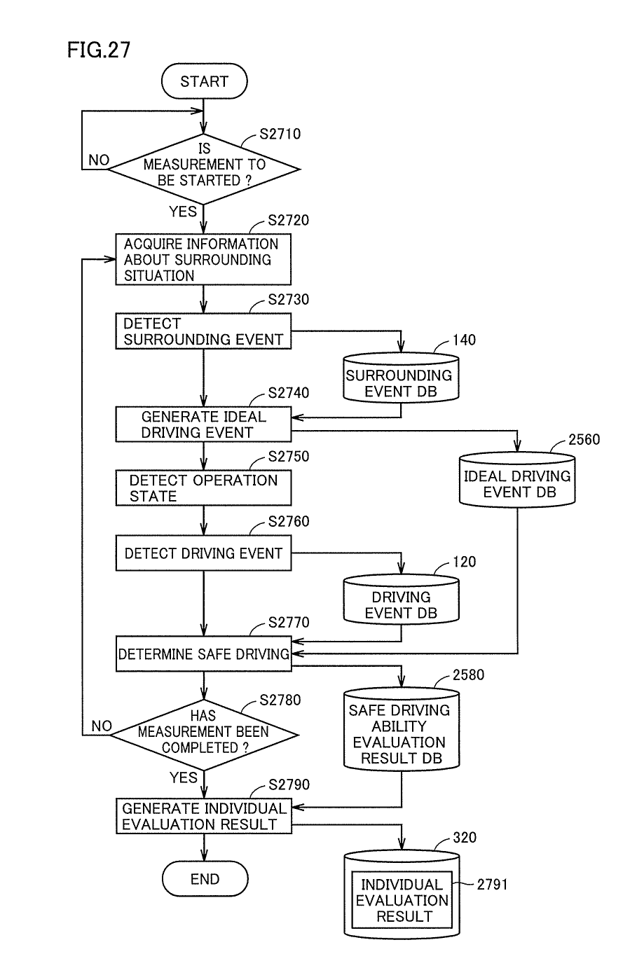

Referring to FIG. 27, the control structure of on-vehicle apparatus 2600 according to an embodiment will be hereinafter described. FIG. 27 is a flowchart showing a part of the process executed by processor 310 provided in on-vehicle apparatus 2600.

In step S2710, processor 310 determines whether measurement is to be started or not. When processor 310 determines that measurement is to be started (YES in step S2710), it causes the control to proceed to step S2720. If not (NO in step S2710), processor 310 returns the control to step S2710.

In step S2720, processor 310 acquires the information about the surrounding situation.

In step S2730, processor 310 detects a surrounding event based on the acquired information about the surrounding situation. Processor 310 stores the detected surrounding event in surrounding event database 140.

In step S2740, processor 310 serves as an ideal driving generation unit 2610 to generate an ideal driving event based on the data stored in surrounding event database 140. Processor 310 stores the generated ideal driving event in ideal driving event database 2560.

In step S2750, processor 310 serves as operation state detection unit 202 to detect the state of the operation performed by the driver of the vehicle equipped with on-vehicle apparatus 200.

In step S2760, processor 310 serves as driving event detection unit 205 to detect events such as acceleration, deceleration, right turns, left turns, and the like, and store the detected events as driving events together with the time of occurrence of each of these events in driving event database 120.

In step S2770, processor 310 serves as safe driving determination unit 208 to determine the degree of safe driving (safety) about driver's driving operation based on (i) the data describing the actually detected driving events and stored in driving event database 120 and (ii) the data describing the ideal driving event and stored in ideal driving event database 2560. For example, processor 310 calculates the difference between each data, and compares this difference with the data predetermined as an acceptable value, thereby determining the degree of safe driving.

In step S2780, processor 310 determines whether the measurement has been completed or not. When processor 310 determines that measurement has been completed (YES in step S2780), it causes the control to proceed to step S2790. If not (NO in step S2780), processor 310 returns the control to step S2720.

In step S2790, processor 310 generates the results of evaluation about the ability of an individual driver. Processor 310 stores the results of the evaluated driving ability as an individual evaluation result 2791 in memory 320. Then, the process ends.

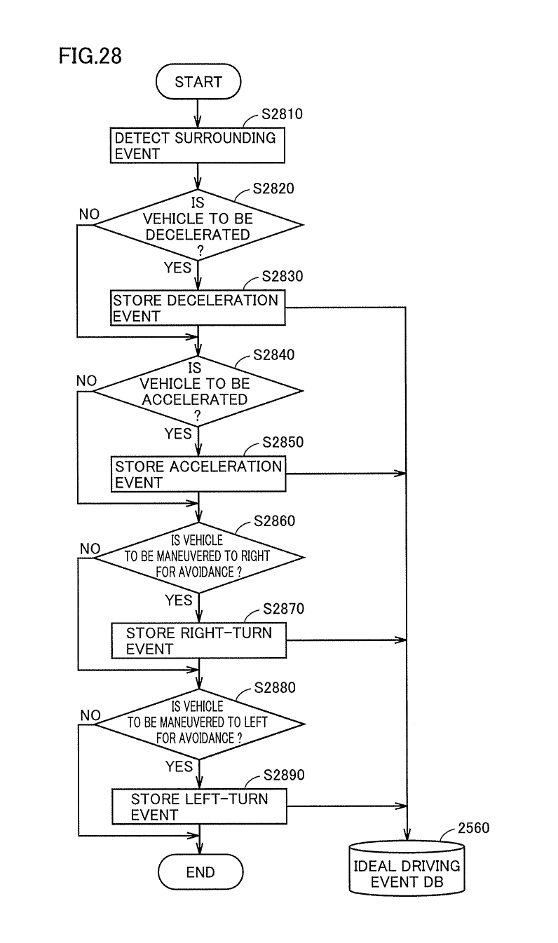

Referring to FIG. 28, generation of the ideal driving event data will be hereinafter described. FIG. 28 is a flowchart showing a part of the process executed by processor 310 for generating ideal driving event data in the on-vehicle apparatus according to an embodiment.

In step S2810, processor 310 serves as surrounding event detection module 135 to detect a surrounding event.

In step S2820, processor 310 determines based on the detected surrounding event whether the vehicle equipped with an on-vehicle apparatus is to be decelerated or not. This determination is made, for example, based on the speed of the vehicle and on the distance between this vehicle and a preceding vehicle detected in front of this vehicle. When processor 310 determines that the vehicle is to be decelerated (YES in step S2820), it causes the control to step S2830. If not (NO in step S2820), processor 310 causes the control to proceed to step S2840.

In step S2830, processor 310 generates data describing an ideal deceleration event, and stores the data in ideal driving event database 2560.

In step S2840, processor 310 determines based on the surrounding event detected in step S2810 whether the vehicle is to be accelerated or not. This determination is made, for example, based on whether the distance between the vehicle and its preceding vehicle has increased or not. When processor 310 determines that the vehicle is to be accelerated (YES in step S2840), it causes the control to step S2850. If not (NO in step S2840), processor 310 causes the control to proceed to step S2860.

In step S2850, processor 310 generates data describing an ideal acceleration event, and stores the data in ideal driving event database 2560. Such data describing an ideal acceleration event may, for example, include the data showing an acceleration event, the accelerator pedal position, and the time change rate of this accelerator pedal position.

In step S2860, processor 310 determines based on the surrounding event detected in step S2810 whether the vehicle is to be maneuvered to the right (or turns right) or not for avoidance. This determination is made, for example, based on the direction of the road extending in front of the vehicle in which the vehicle travels, the arrow shown by the detected traffic signal, and the like. When processor 310 determines that the vehicle is to be maneuvered to the right (turns right) for avoidance (YES in step S2860), it causes the control to step S2870. If not (NO in step S2860), processor 310 causes the control to proceed to step S2880.

In step S2870, processor 310 generates data describing an ideal right-turn event, and stores the data in ideal driving event database 2560. The data describing an ideal right-turn event may, for example, include the data showing a right-turn event and the rotation speed of the steering wheel to the right (clockwise direction).

In step S2880, processor 310 determines based on the surrounding event detected in step S2810 whether the vehicle is to be maneuvered to the left (or turns left) or not for avoidance. This determination is made, for example, based on the direction of the road extending in front of the vehicle in which the vehicle travels, the arrow shown by the detected traffic signal, and the like. When processor 310 determines that the vehicle is to be maneuvered to the left (turns left) for avoidance (YES in step S2880), it causes the control to step S2890. If not (NO in step S2880), processor 310 ends the control.

In the above description, the order of performing the determination steps (steps S2820, S2840, S2860, and S2880) is not limited to the order shown in FIG. 5. In another aspect, the determination steps may be performed in parallel.

[Data Structure]

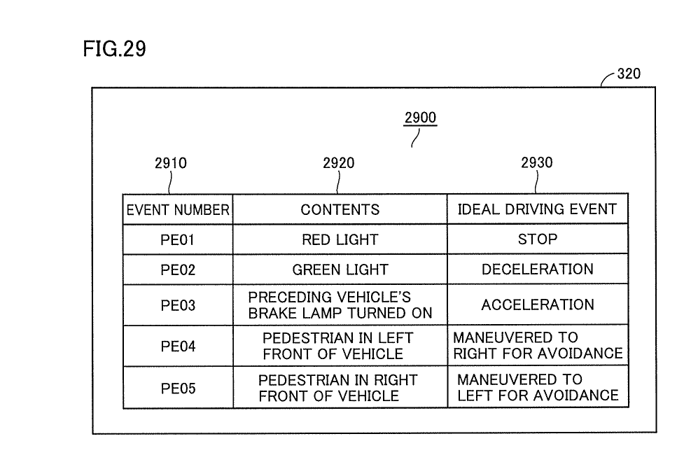

Referring to FIG. 29, the data structure of on-vehicle apparatus 2600 according to an embodiment will be hereinafter described. FIG. 29 is a diagram conceptually showing a manner of data storage in memory 320.

In an aspect, memory 320 includes a table 2900. Table 2900 includes an event number 2910, contents 2920, and an ideal driving event 2930.

Event number 2910 is used for identifying a surrounding event (PE) or a driving event (DE). Contents 2920 show a surrounding event of the vehicle (for example, a red light, a green light, and the like), an event showing the state of the running vehicle (for example, abrupt deceleration, abrupt acceleration, and the like).

Ideal driving event 2930 shows an ideal driving event for contents 2920 specified by event number 2910. For example, contents 2920 corresponding to event number 2910 showing PE01 are defined as a “red light”. Ideal driving event 2930 for such contents 2920 is defined as “stop”. Therefore, for example, when “preceding vehicle's brake lamp turned ON” is detected as a surrounding event, ideal driving event 2930 is defined as “deceleration”.

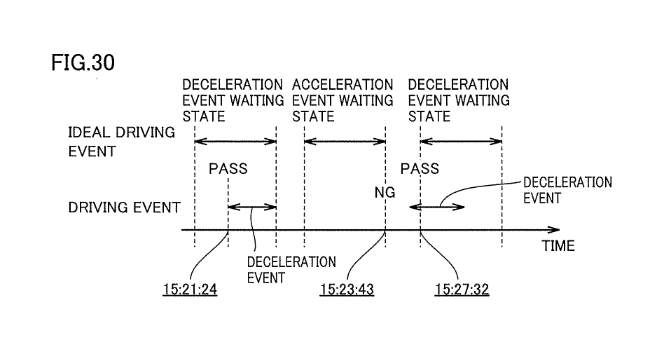

FIG. 30 shows a diagram in which an image of correspondence between the ideal driving event and the driving event is represented on a time-axis base. FIG. 30 is a diagram showing the relation between ideal driving events and actual driving events.

First, when on-vehicle apparatus 2600 detects a surrounding event for which the vehicle is to be decelerated, the ideal driving event is brought into a deceleration event waiting state. In such a deceleration event waiting state, when processor 310 serves as driving event detection unit 205 to actually detect the appropriate driving event (deceleration), processor 310 determines that the driver performs ideal driving. Processor 310 associates the determination results, for example, with the driving event (=deceleration event) and an evaluation result “PASS”, and stores the associated results in result storage unit 209 of memory 320.

In the example shown in FIG. 30, for example, the time period elapsed from when the deceleration event waiting state is started upon detection of a red light until when the deceleration event is actually started at the time 15:21:24 may be shorter than a predetermined reference time period. In such a situation, processor 310 determines that ideal driving is performed, and determines the evaluation result of the deceleration event as “PASS”.

Also as a subsequent example, there may be a case, for example, where acceleration is not actually performed during a time period from when the acceleration event waiting state is started upon detection of a green light until the time 15:23:43. In this case, when this time period is longer than a predetermined time period, processor 310 may determine that an ideal driving event (in other words, an acceleration event) was not performed. In such a situation, processor 310 determines the driving event occurring in the acceleration event waiting state as “NG”.

Then, for example, another deceleration event may be detected by detection of a preceding vehicle's brake lamp. In this case, when deceleration is actually performed before the time (15:27:32) at which the deceleration event was detected, processor 310 determines that this deceleration is an ideal driving event, and associates “PASS” as a determination result with this deceleration.

In this way, during the operation of on-vehicle apparatus 2600, processor 310 serves as safe driving determination unit 208 to make the above-described evaluation for each event, and store the evaluation results as safe driving evaluation results in result storage unit 209.

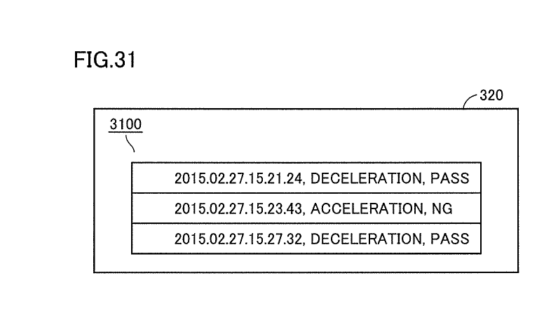

Referring to FIG. 31, the data structure of on-vehicle apparatus 2600 will be hereinafter further described. FIG. 31 is a diagram conceptually showing a manner of data storage in memory 320. Memory 320 stores a table 3100. Table 3100 stores data showing pass/fail results (for example, PASS, NG, and the like) as results evaluated by processor 310. In an aspect, these evaluation results are transmitted to a provider of on-vehicle apparatus 2600, or the third parties utilizing the evaluation results (for example, vehicle insurance companies, organizations that collect data related to the vehicle operations, and the like), and then used thereby.

[Control Structure]

The following is an explanation about the determination as to whether the driving event corresponding to an ideal driving event has been actually performed or not.

On-vehicle apparatus 2600 according to an embodiment reads the ideal driving event information from memory 320. Then, if an event occurs, on-vehicle apparatus 2600 compares the information about this event with the information about the past event one event before this event. When the information about this event does not match with the information about the past event, processor 310 sets the state of on-vehicle apparatus 2600 as “waiting”. The operation mode of on-vehicle apparatus 2600 turns into a state of waiting occurrence of an actual driving event performed by a driver.

Then, processor 310 reads the actually detected driving event from memory 320, and compares the detected driving event with the driving event expected as ideal driving. If these driving events match with each other, processor 310 classifies the detected driving event as “PASS”, and stores it as a log. Then, processor 310 cancels the event waiting state of on-vehicle apparatus 2600. On the other hand, when processor 310 does not detect the appropriate event even in the driving event waiting state, that is, when the driver does not perform ideal driving, processor 310 classifies the driving event waiting state as “NG” and stores it as a log, and then, cancels the event waiting state.

[Flowchart]

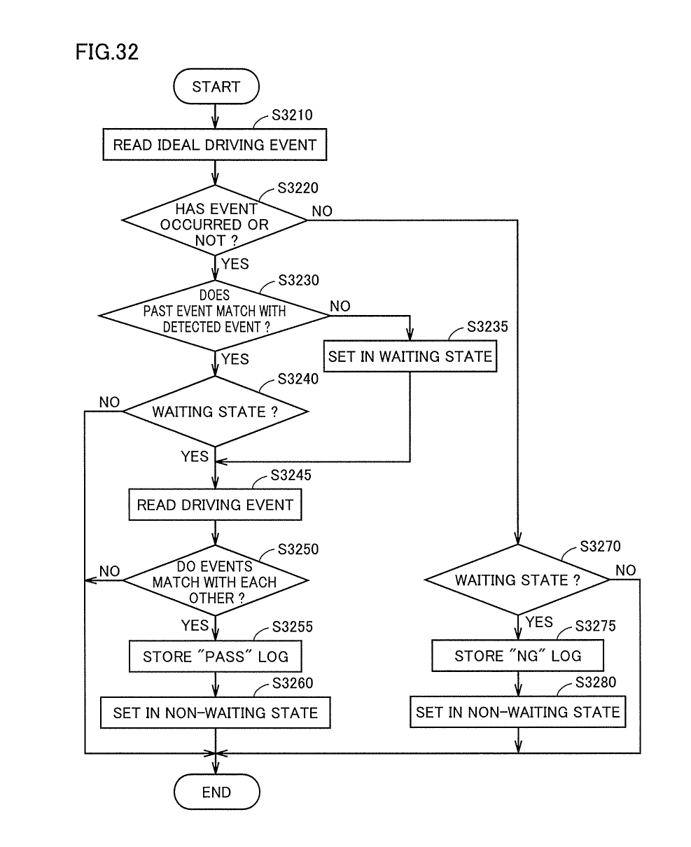

Referring to FIG. 32, the above-described determination in on-vehicle apparatus 2600 will be hereinafter described. FIG. 32 is a flowchart showing a part of the process executed by processor 310.

In step S3210, processor 310 reads the ideal driving event data prepared in advance from memory 320. Ideal driving event data is prepared, for example, by the provider of on-vehicle apparatus 2600, the business operator providing service using the data obtained from on-vehicle apparatus 2600 (for example, a vehicle insurance company), and the like.

In step S3220, processor 310 serves as surrounding event detection unit 206 to determine whether a surrounding event (for example, the signal turned red, a red light turned into a green light, the brake lamp of the preceding vehicle was turned on, and the like) has actually occurred or not. When processor 310 determines that the surrounding event actually occurs (YES in step S3220), it causes the control to proceed to step S3230. If not (NO in step S3220), processor 310 causes the control to proceed to step S3270.

In step S3230, processor 310 compares the detected surrounding event with the past surrounding event, to determine whether these events match with each other. When processor 310 determines that these surrounding events match with each other (YES in step S3230), processor 310 causes the control to proceed to step S3240. If not (NO in step S3230), processor 310 causes the control to proceed to step S3235.

In step S3235, processor 310 sets the operation mode of on-vehicle apparatus 2600 to be in a driving event waiting state.

In step S3240, processor 310 determines whether the operation mode of on-vehicle apparatus 2600 is set to be in a driving event waiting state or not. When processor 310 determines that the operation mode is set to be in a waiting state (YES in step S3240), processor 310 causes the control to proceed to step S3245. If not (NO in step S3240), processor 310 ends the process.

In step S3245, processor 310 reads a driving event. More specifically, processor 310 serves as driving event detection unit 205 to read the actually detected driving event into memory 320.

In step S3250, processor 310 determines whether the detected driving event and the ideal driving event match with each other. For example, processor 310 determines whether the difference between the time period from detection of the surrounding event until the start of the actual driving event and the time period defined for the ideal driving event falls within a predetermined acceptable range or not. When processor 310 determines that these events match with each other (YES in step S3250), it causes the control to proceed to step S3255. If not (NO in step S3250), processor 310 ends the process.

In step S3255, processor 310 determines the detected actual driving event as “PASS”, and stores the driving event and the determination result as a log.

In step S3260, processor 310 switches the operation mode of on-vehicle apparatus 2600 from a “waiting state” into a “non-waiting state”.

In step S3270, processor 310 determines whether on-vehicle apparatus 2600 is in a waiting state or not. This determination is made, for example, based on the flag showing the operation mode of on-vehicle apparatus 2600. When processor 310 determines that on-vehicle apparatus 2600 is in a waiting state (YES in step S3270), it causes the control to proceed to step S3275. If not (NO in step S3270), processor 310 ends the process.

In step S3275, processor 310 classifies the waiting state as “NG”, and records it as a log. In this case, in the case where not only the driving event was not detected but also a special driving event does not occur within a prescribed time period, this time period may be classified as “NG” in order to show that the determination about safe driving is not performed during this time period.

In step S3280, processor 310 sets the operation mode of on-vehicle apparatus 2600 as a “non-waiting state”.

[Data Structure]

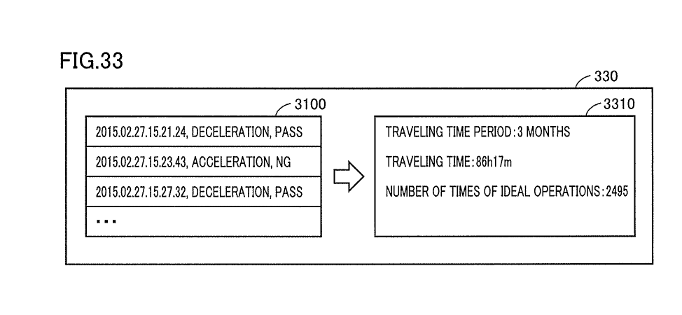

Referring to FIG. 33, the final driver evaluation results will be hereinafter described. FIG. 33 is a diagram showing a manner of deriving evaluation results.

During an optional time period, on-vehicle apparatus 2600 makes measurements about the operation of the user (that is, a driver) of on-vehicle apparatus 2600, and stores the traveling time period, the traveling time and the like together with the evaluation results. Furthermore, the number in accordance with ideal driving is defined as the “number of ideal operations”, and the ratio of the number of times of ideal operations relative to the number of occurrence of the surrounding events is defined as an “ideal operation ratio”, which are then subjected to statistical processing as evaluation results of the driver's safe driving ability, thereby presenting the processing results. In addition, such processing may be performed not within on-vehicle apparatus 2600 but by an external computer system that can communicate with on-vehicle apparatus 2600.

As shown in FIG. 33, processor 310 reads the data in table 3100 from memory 320 into RAM 330. Processor 310 uses the data included in table 3100 to calculate the traveling time period, the traveling time, the number of times of ideal operations, and the ideal operation ratio. The traveling time period is calculated, for example, using the oldest date and the newest date among the time information in table 3100. The traveling time is calculated, for example, using the oldest date and time and the newest date and time among the above-described time information. Alternatively, in another aspect, the ranges of the time period and the time that are designated in advance may be used to select a fixed time period from an optional start time as a traveling time period or a traveling time. In the example shown in FIG. 33, each calculation result is obtained as a data set 3310.

As described above, on-vehicle apparatus 2600 according to an embodiment may derive an ideal operation method based on the acquired surrounding situation, and compare the actual operation state with the ideal operating method, to determine whether the driver safely drives a vehicle or not.

Thereby, it becomes possible to measure the driver's safe driving degree that cannot be determined only by acquiring the operation state. For example, it becomes possible to evaluate whether or not the driver performs an operation according to the traffic rules and morals, for example: the driver performed an operation of stopping the vehicle at a temporary-stop intersection; the driver checked the existence or absence of a pedestrian to perform a safe driving operation; and the like. Accordingly, it becomes possible not only to urge the driver to conduct careful driving or gentle driving using only acceleration, but also to cause the driver to consciously perform an essentially safe driving operation.

<Calculation of Insurance Fee Based on Accident Rate Correlation Information>

Another aspect of an embodiment will be hereinafter described. The present aspect is different from the above-described aspect in that, as an additional input, the accident rate correlation information including the causal relation of the accident rate is used to automatically calculate the vehicle insurance fee. Furthermore, the on-vehicle apparatus according to an embodiment may derive autocorrelation information. Also in an embodiment, a computer server collects, from a plurality of users, (i) ideal driving determination results obtained from on-vehicle apparatus 2600, and (ii) driving record information including a summary about occurrence or nonoccurrence of accidents and the like during the time period in which a vehicle equipped with on-vehicle apparatus 2600 travels. The computer server derives the characteristics of the reaction time and the causal relation of the accident rate through known statistical processing, so that it can calculate an insurance fee in accordance with the characteristics of the reaction time.

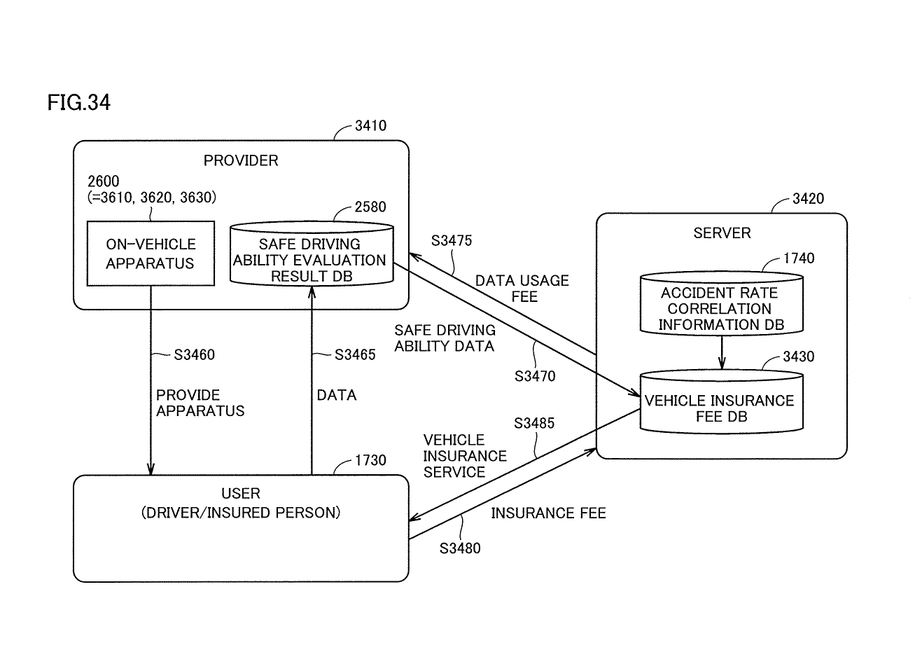

First, referring to FIG. 34, a practical example using on-vehicle apparatus 2600 according to an embodiment will be hereinafter described. FIG. 34 is a diagram showing the relation between a person concerned who uses data obtained by on-vehicle apparatus 2600 and the data.

In an aspect, a provider 3410 of on-vehicle apparatus 2600 serving as a user of on-vehicle apparatus 2600 has an on-vehicle apparatus 2600 and a safe driving ability evaluation result database 2580.

Server 3420 of the vehicle insurance company includes an accident rate correlation information database 1740 and a vehicle insurance fee database 3430.

User 1730 serving as a driver or an insured person is provide with on-vehicle apparatus 2600 from provider 3410, or receives insurance service from the vehicle insurance company.

More specifically, in step S3460, provider 3410 provides user 1730 with on-vehicle apparatus 2600.

In step S3465, user 1730 provides a provider 3410 with the data acquired by using on-vehicle apparatus 2600. The provided data is accumulated, for example, in safe driving ability evaluation result database 2580.

In step S3470, provider 1710 reads the safe driving ability data from safe driving ability evaluation result database 2580, and transmits the read data to server 3420 managed by the vehicle insurance company. The transmitted data is stored, for example, in vehicle insurance fee database 3430.

In step S3475, the vehicle insurance company pays a data usage fee to provider 3410 in response to reception of the safe driving ability data from provider 3410.

In step S3480, user 1730 pays an insurance fee to the vehicle insurance company. The payment information is accumulated in server 3420 of the vehicle insurance company.

In step S3485, the vehicle insurance company provides vehicle insurance service to user 1730. The insurance fee of the service provided at this time is calculated, for example, based on the data stored in vehicle insurance fee database 3430.

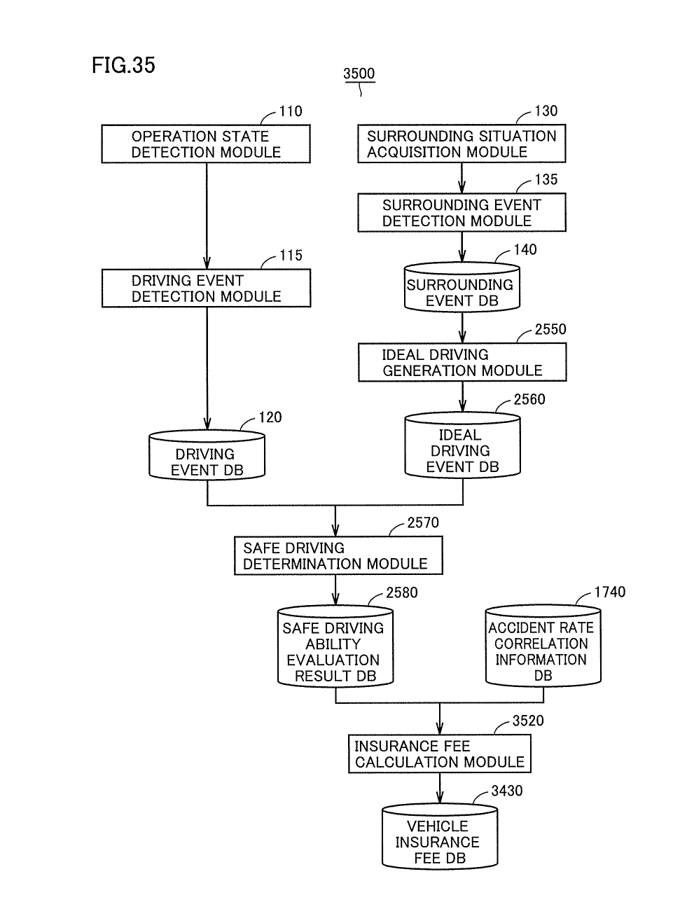

Referring to FIG. 35, the configuration of a system 3500 according to another aspect will be hereinafter described. FIG. 35 is a diagram showing an example of the configuration of system 3500. System 3500 additionally includes an accident rate correlation information database 1740, an insurance fee calculation module 3520, and a vehicle insurance fee database 3430 in the configuration of system 2500 shown in FIG. 25.

In an embodiment, the accident rate correlation information including the causal relation of the accident rate is further used. Insurance fee calculation module 3520 automatically calculates a vehicle insurance fee.

[Derivation of Accident Rate Correlation Information]

Also in the present aspect, as in the case shown in FIG. 19, the driving record information and the reaction time information obtained from a plurality of users may be transmitted to server 3420 of the vehicle insurance company. The information to be transmitted and the manner of transmission are the same as those described with reference to FIG. 19. Therefore, detailed description thereof will not be repeated.

According to an embodiment, not only the reaction time information but also the driving record information including occurrence or nonoccurrence of accidents is used. Accordingly, a potential accident risk can be derived from the reaction time characteristics. Consequently, it becomes possible to calculate an accident risk with accuracy higher than that employed in the current insurance system in which the insurance fee is calculated using ages, traveling distance, and abrupt or slow acceleration.

<Detection of Driving Event from Surrounding Situation>

Another aspect of an embodiment will be hereinafter described. The present aspect is different from the above-described aspect in that the driving event is detected from the information obtained by a surrounding situation detection unit like a camera.

In an aspect, a driving event may be detected from images obtained by camera 300 by using the vehicle behavior estimation technique referred to as “ego-motion” that is a known technique.

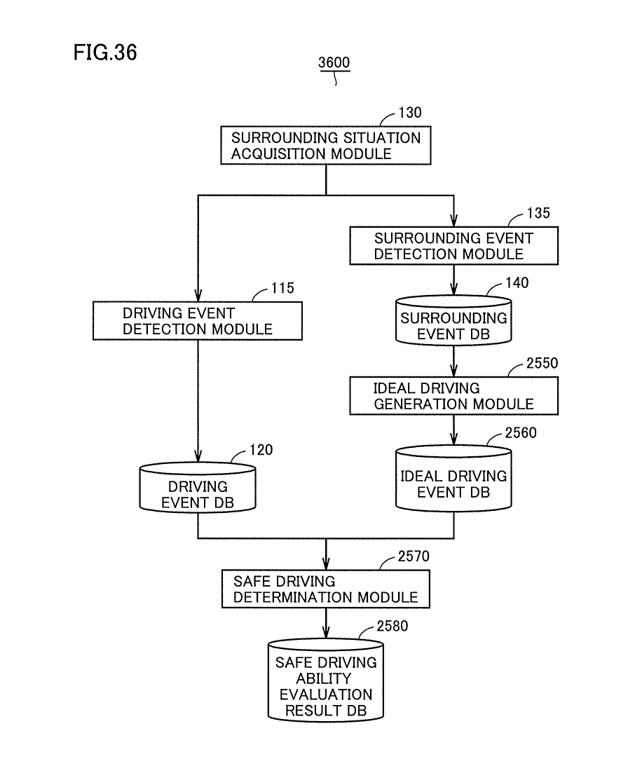

Referring to FIG. 36, the configuration of a system 3600 will be hereinafter described. FIG. 36 is a diagram conceptually showing the configuration of system 3600. System 3600 is different from system 2500 in that it has a configuration of system 2500 shown in FIG. 25 excluding operation state detection module 110.

Driving event detection module 115 is configured to detect a driving event based on the surrounding situation acquired by surrounding situation acquisition module 130. In an embodiment, surrounding situation acquisition module 130 is implemented by camera 300.

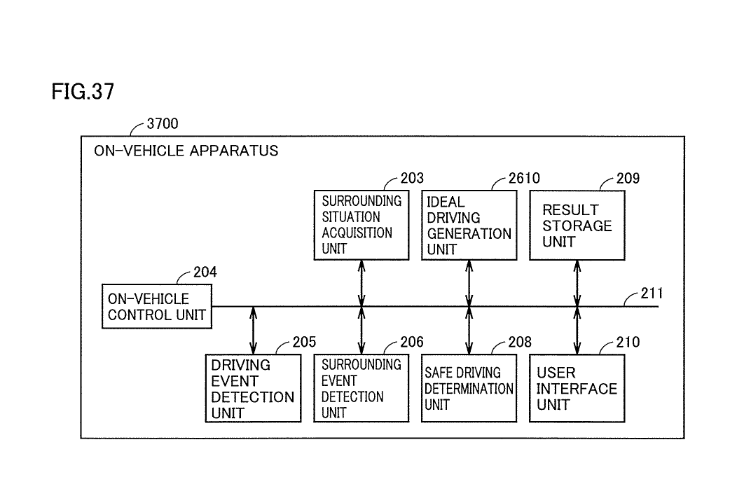

Referring to FIG. 37, the configuration of an on-vehicle apparatus 3700 according to the present aspect will be hereinafter described. FIG. 37 is a diagram showing the configuration of on-vehicle apparatus 3700.

On-vehicle apparatus 3700 has a configuration of on-vehicle apparatus 2600 shown in FIG. 26 excluding operation state detection unit 202. Since other configurations are the same as those of on-vehicle apparatus 2600 shown in FIG. 26, the detailed description thereof will not be repeated.

As described above, according to an embodiment, since only a camera has to be provided as a sensor, components for detecting a driving event are not required. Consequently, the cost for on-vehicle apparatus 3700 can be reduced.

<Detection of Surrounding Event Based on Communication with Object>

Another aspect of an embodiment will be hereinafter described. A surrounding event may be detected not by using a sensor such as a camera, but by using communication between vehicles, communication between a vehicle and an infrastructure, and communication between a vehicle and a pedestrian, in which case each communication is transmitted from an object to be detected. For example, a surrounding event may be detected by a wireless device in place of surrounding situation acquisition module 130. Another aspect according to an embodiment may be implemented, for example, by on-vehicle apparatus 2600.

In an aspect, a traffic light/a road sign may submit/show information that is used for detecting a surrounding event. For example, a traffic light is equipped with a transmitter for transmitting a signal including its position information in advance. For example, each time a signal changes, the transmitter transmits the signal. When a vehicle receives the signal, it recognizes that the traffic signal has changed from green to yellow, from yellow to red, or from red to green. Based on this recognition, on-vehicle apparatus 2600 may detect a surrounding event.

In another example, the road sign placed at an intersection includes a transmitter for transmitting a signal including the present address. This transmitter is configured to transmit a signal, for example, in a fixed direction on the road. When a vehicle or on-vehicle apparatus 2600 receives this signal, it can recognize that the vehicle is approaching the intersection. In consideration of this recognition result, on-vehicle apparatus 2600 may determine the degree of safe driving.

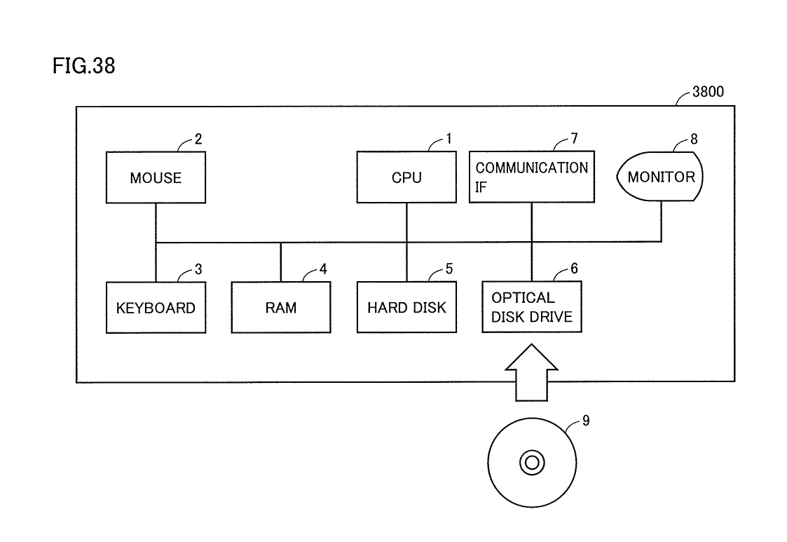

Referring to FIG. 38, the configuration of a server will be hereinafter described. FIG. 38 is a block diagram showing the hardware configuration of a computer 3800 implementing a server. Computer 3800 is formed of main components including: a CPU 1 executing a program; a mouse 2 and a keyboard 3 receiving an instructions from a user of computer 3800; a RAM 4 storing, in a volatile manner, the data generated by execution of the program by CPU 1 or the data input through mouse 2 or keyboard 3; a hard disk 5 storing data in a non-volatile manner; an optical disk drive 6; a communication IF (Interface) 7; and a monitor 8. These components are connected to a bus. A CD-ROM and other optical disks 9 are mounted on optical disk drive 6. Communication IF 7 includes a USB (Universal Serial Bus) interface, a wired LAN (Local Area Network), a wireless LAN, a Bluetooth (registered trademark) interface, and the like, but are not limited thereto.

The process in computer 3800 is implemented by software executed by each hardware and CPU 1. Such software may be stored in hard disk 5 in advance. Furthermore, the software may be stored in a CD-ROM or other computer-readable nonvolatile data recording media, and distributed as a program product. Alternatively, the software may be provided as a program product that can be downloaded by the information provider connected to the Internet or other networks. Such software is read from the data recording medium by optical disk drive 6 or other data readers, or downloaded through communication IF 7, and then stored temporarily in hard disk 5. This software is read from hard disk 5 by CPU 1, and stored in RAM 4 in an executable program format. CPU 1 executes this program.

Each component forming computer 3800 shown in FIG. 38 is commonly used. Therefore, the essential part according to the disclosed embodiment can also be regarded as a program stored in computer 3800. Since the operation of each hardware of computer 3800 is well known, detailed description thereof will not be repeated.

A data recording medium is not limited to a CD-ROM, an FD (Flexible Disk) and a hard disk, but may be a nonvolatile data recording medium fixedly carrying a program, such as a magnetic tape, a cassette tape, an optical disk (MO (Magnetic Optical Disc)/MD (Mini Disc)/DVD (Digital Versatile Disc)), and a semiconductor memory such as an IC card (Integrated Circuit) card (including a memory card), an optical card, a mask ROM, an EPROM (Electronically Programmable Read-Only Memory), an EEPROM (Electronically Erasable Programmable Read-Only Memory), a flash ROM, or the like.

The program referred herein may include not only a program directly executable by a CPU, but also a program in a source program format, a compressed program, an encrypted program, and the like.

According to an embodiment, the existence or absence of an object to be detected for a surrounding event can be detected irrespective of the accuracy of image recognition. Accordingly, it becomes possible to technically readily maintain a relatively high accuracy for measuring the reaction time.

[Summary]

The disclosed technique is characterized by determining the driver's safe driving ability by measuring the time period from the timing of occurrence of a change in the surrounding situation that should be reflected in the driving action until the time when the driver responds to the change, makes a determination and performs an operation therefor. The effect of this technique lies in that the driver's reaction time is measured to visualize the decreased driving ability caused by aging or poor health, which cannot be determined only based on the driving roughness such as an abrupt operation, abrupt acceleration, or abrupt deceleration. For example, in the case where the driver notices lighting-ON of a brake lamp of its preceding vehicle and then slowly applies a brake to stop the vehicle, (i) if the reaction speed is relatively fast, it may be determined that safe driving is performed with a sufficient distance maintained between the vehicles; however, (ii) if the reaction speed is relatively slow, there may be a dangerous driving operation, for example, the driver's vehicle suddenly approaches its preceding vehicle. According to the technique in the present disclosure, it can be determined that the decreased safe driving ability is caused by the decreased reaction speed due to the driver's poor health or aging.

According to an embodiment, ideal driving event information predicted from the surrounding situation information is used for determining safe driving. The on-vehicle apparatus according to an embodiment can determine whether an operation dealing with the surrounding situation such as a signal, a pedestrian and a vehicle is safely performed or not. Accordingly, it becomes possible to detect each driver's driving action in comply with traffic regulations to improve the accuracy of the safe driving ability determination and accident risk estimation.

In an embodiment, the apparatus mounted in a vehicle may perform all of the processes. In another aspect, the computer receiving information from the vehicle may perform all of the processes. In still another aspect, part of the processes may be performed by the on-vehicle apparatus while other processes may be performed by an external computer.

In summary, the technical idea according to the present disclosure may be implemented by the following configuration.

An on-vehicle apparatus according to an aspect may evaluate a driving ability. The on-vehicle apparatus includes: a memory for storing a program; and at least one processor for executing an instruction. At least one processor is configured to detect a state of an operation of a vehicle by a driver (for example, the degree of pressing an accelerator pedal, the traveling speed of the vehicle, the operation state of an ABS, time, the engine rotation speed, the change in the engine rotation speed, and the like), detect a driving state of the vehicle based on the state of the operation (for example, acceleration, deceleration, right turns, left turns, ON or OFF of a light, and the like), acquire a surrounding situation of the vehicle, detect a surrounding event of the vehicle from the acquired surrounding situation, calculate a reaction time from occurrence of the surrounding event until execution of the operation of the vehicle based on the detected driving state of the vehicle and the detected surrounding event, and output the calculated reaction time. The reaction time may be output to the outside of on-vehicle apparatus 200, a memory recording the reaction time, a monitor, and the like.

One or more processors of the on-vehicle apparatus according to another aspect are configured to acquire a surrounding situation of a vehicle, detect a surrounding event of the vehicle from the acquired surrounding situation, detect a driving state of the vehicle from the acquired surrounding situation, calculate a reaction time from occurrence of the surrounding event until execution of an operation of the vehicle based on the detected driving state of the vehicle and the detected surrounding event, and evaluate a driving ability of a driver of the vehicle based on the calculated reaction time and a predetermined reference time.

Preferably, in the on-vehicle apparatus having one of the above-described configurations, the processor may detect the driving state and a time of execution of the operation of the vehicle.

Preferably, in the on-vehicle apparatus having one of the above-described configurations, the processor may detect occurrence of the surrounding event and a time of occurrence of the surrounding event.

Preferably, in the on-vehicle apparatus having one of the above-described configurations, the processor may calculate a difference between a time of occurrence of the surrounding event and a time of execution of the operation of the vehicle.

Preferably, the processor is programmed to detect a state of the vehicle based on the state of the operation of the vehicle, and calculate the reaction time further based on the state of the vehicle.

Preferably, in the on-vehicle apparatus having one of the above-described configurations, the processor is programmed to receive a signal transmitted from a camera or from a surrounding of the vehicle.

According to an embodiment, a method for a computer to evaluate a driving ability is provided. The method causes a processor of the computer to: receive data that shows a driving state of a vehicle based on a state of an operation of the vehicle; receive data that shows a surrounding event of the vehicle from a surrounding situation of the vehicle; calculate a reaction time from occurrence of the surrounding event until execution of the operation of the vehicle based on the driving state of the vehicle and the surrounding event; and evaluate the driving ability of a driver of the vehicle based on the calculated reaction time and a predetermined reference time.

Preferably, the data that shows a driving state may include the driving state and a time of execution of the operation of the vehicle.

Preferably, the data that shows a surrounding event may include an identification of the surrounding events and a time of occurrence of the surrounding event.

Preferably, calculating a reaction time may include calculating a difference between a time of occurrence of the surrounding event and a time of execution of the operation of the vehicle.

Preferably, the method further includes receiving data that shows a state of the vehicle based on the state of the operation of the vehicle. Calculating a reaction time may include calculating the reaction time further based on the state of the vehicle.

Preferably, the method further includes calculating an insurance fee of the vehicle based on accident rate correlation information prepared in advance.

According to an embodiment, an apparatus for evaluating a driving ability includes: a memory for storing a program; and a processor for executing a plurality of instructions. The processor is programmed to, when the plurality of instructions are executed, detect a state of an operation of a vehicle, detect a driving state of the vehicle based on the state of the operation of the vehicle, acquire a surrounding situation of the vehicle, detect a surrounding event of the vehicle from the acquired surrounding situation, generate an ideal driving state of the vehicle based on the surrounding event, and determine driving safety of the vehicle based on the detected driving state of the vehicle and the generated ideal driving state.

Preferably, the processor is programmed to detect the driving state and a time of execution of the operation of the vehicle.

Preferably, the processor is programmed to detect occurrence of the surrounding event and a time of occurrence of the surrounding event.

Preferably, the ideal driving state shows an operation that is to be performed in the vehicle in accordance with the detected surrounding event.

Preferably, the processor is programmed to determine the driving safety based on a difference between the detected driving state of the vehicle and the ideal driving state.

Preferably, the processor is programmed to receive a signal transmitted from a camera or from a surrounding of the vehicle.

A method for evaluating a driving ability according to an embodiment includes: acquiring a state of an operation of a vehicle; detect a driving state of the vehicle based on the state of the operation of the vehicle (an actual driving event); acquire a surrounding situation of the vehicle; detect a surrounding event of the vehicle from the acquired surrounding situation; generate an ideal driving state of the vehicle based on the surrounding event; and determine driving safety of the vehicle based on the detected driving state of the vehicle and the generated ideal driving state.

Preferably, detecting a driving state includes detecting the driving state and a time of execution of the operation of the vehicle.

Preferably, detecting a surrounding event includes detecting occurrence of the surrounding event and a time of occurrence of the surrounding event.

Preferably, the ideal driving state shows an operation that is to be performed in the vehicle in accordance with the detected surrounding event.

Preferably, determining driving safety includes determining the driving safety based on a difference between the detected driving state of the vehicle and the ideal driving state.

Preferably, detecting a surrounding event includes receiving a signal from a camera or receiving a signal transmitted from a surrounding of the vehicle.

Each of the above-mentioned modules may be implemented as hardware like an ASIC (Application Specific Integrated Circuit), other circuits or a part of the circuit, as software for implementing a function implemented by the module, or in combination with hardware and software.

Furthermore, each of the above-described methods may be performed by one or more processors.

An on-vehicle apparatus according to another aspect may detect a driving state from a surrounding situation acquisition unit like a camera. For example, the on-vehicle apparatus serving as an apparatus for evaluating a driving ability includes: a surrounding situation acquisition unit for acquiring a surrounding situation of a vehicle; a surrounding event detection unit for detecting a surrounding event of the vehicle from the acquired surrounding situation; a driving event detection unit for detecting a driving state of the vehicle from the acquired surrounding situation; a reaction time measurement unit for calculating a reaction time from occurrence of the surrounding event until execution of an operation of the vehicle based on the detected driving state of the vehicle and the detected surrounding event; and a driving ability evaluation unit for evaluating the driving ability of a driver of the vehicle based on the calculated reaction time and a predetermined reference time.

Although the invention achieved by the present inventor has been specifically described based on the embodiments as above, it goes without saying that the present invention is not limited to those embodiments and can be variously modified without departing from the scope of the invention.

What is claimed is:

1. An apparatus for evaluating a driving ability, the apparatus comprising:
a memory for storing a program including a plurality of instructions; and
a processor for executing the plurality of instructions, the processor being coupled to the memory,
the processor being programmed to, when the plurality of instructions are executed,
detect a state of an operation of a vehicle,
detect a driving state of the vehicle based on the state of the operation of the vehicle,
acquire a surrounding situation of the vehicle,
detect a surrounding event of the vehicle from the acquired surrounding situation,
calculate a reaction time from occurrence of the surrounding event until execution of the operation of the vehicle based on the detected driving state of the vehicle and the detected surrounding event, and
output the calculated reaction time.

2. The apparatus according to claim 1, wherein the processor is programmed to detect the driving state and a time of execution of the operation of the vehicle.

3. The apparatus according to claim 1, wherein the processor is programmed to detect occurrence of the surrounding event and a time of occurrence of the surrounding event.

4. The apparatus according to claim 1, wherein the processor is programmed to calculate a difference between a time of occurrence of the surrounding event and a time of execution of the operation of the vehicle.

5. The apparatus according to claim 1, wherein the processor is further programmed to
detect a state of the vehicle based on the state of the operation of the vehicle, and
calculate the reaction time further based on the state of the vehicle.

6. The apparatus according to claim 1, wherein the processor is programmed to receive a signal transmitted from a camera or from a surrounding of the vehicle.

7. A method for a computer to evaluate a driving ability, the method comprising:
receiving data that shows a driving state of a vehicle based on a state of an operation of the vehicle;
receiving data that shows a surrounding event of the vehicle from a surrounding situation of the vehicle;
calculating a reaction time from occurrence of the surrounding event until execution of the operation of the vehicle based on the driving state of the vehicle and the surrounding event; and
evaluating the driving ability of a driver of the vehicle based on the calculated reaction time and a predetermined reference time.

8. The method according to claim 7, wherein the data that shows a driving state includes the driving state and a time of execution of the operation of the vehicle.

9. The method according to claim 7, wherein the data that shows a surrounding event includes an identification of the surrounding events and a time of occurrence of the surrounding event.

10. The method according to claim 7, wherein calculating a reaction time includes calculating a difference between a time of occurrence of the surrounding event and a time of execution of the operation of the vehicle.

11. The method according to claim 7, further comprising receiving data that shows a state of the vehicle based on the state of the operation of the vehicle, wherein
calculating a reaction time includes calculating the reaction time further based on the state of the vehicle.

12. The method according to claim 7, further comprising calculating an insurance fee of the vehicle based on accident rate correlation information prepared in advance.

13. An apparatus for evaluating a driving ability, the apparatus comprising:
a memory for storing a program including a plurality of instructions; and
a processor for executing the plurality of instructions, the processor being coupled to the memory,
the processor being programmed to, when the plurality of instructions are executed,
detect a state of an operation of a vehicle,
detect a driving state of the vehicle based on the state of the operation of the vehicle,
acquire a surrounding situation of the vehicle,
detect a surrounding event of the vehicle from the acquired surrounding situation,
generate an ideal driving state of the vehicle based on the surrounding event, and
determine driving safety of the vehicle based on the detected driving state of the vehicle and the generated ideal driving state.

14. The apparatus according to claim 13, wherein the processor is programmed to detect the driving state and a time of execution of the operation of the vehicle.

15. The apparatus according to claim 13, wherein the processor is programmed to detect occurrence of the surrounding event and a time of occurrence of the surrounding event.

16. The apparatus according to claim 13, wherein the ideal driving state shows an operation that is to be performed in the vehicle in accordance with the detected surrounding event.

17. The apparatus according to claim 13, wherein the processor is programmed to determine the driving safety based on a difference between the detected driving state of the vehicle and the ideal driving state.

18. The apparatus according to claim 13, wherein the processor is programmed to receive a signal transmitted from a camera or from a surrounding of the vehicle.

19. An apparatus for evaluating a driving ability, the apparatus comprising:
a memory for storing a program including a plurality of instructions; and
a processor for executing the plurality of instructions, the processor being coupled to the memory,
the processor being programmed to, when the plurality of instructions are executed,
acquire a surrounding situation of a vehicle,
detect a surrounding event of the vehicle from the acquired surrounding situation,
detect a driving state of the vehicle from the acquired surrounding situation,
calculate a reaction time from occurrence of the surrounding event until execution of an operation of the vehicle based on the detected driving state of the vehicle and the detected surrounding event, and
evaluate the driving ability of a driver of the vehicle based on the calculated reaction time and a predetermined reference time.

20. The apparatus according to claim 19, wherein the processor is programmed to detect the driving state and a time of execution of the operation of the vehicle.
